(19) United States
(12) Patent Application Publication
(10) Pub. No.: US 2025/0060859 A1
(43) Pub. Date: Feb. 20, 2025

(54) CONTROL METHOD, CONTROL DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Shiki FURUI, Matsumoto-shi (JP)

(21) Appl. No.: 18/451,312

(22) Filed: Aug. 17, 2023

(30) Foreign Application Priority Data
Aug. 17, 2022 (JP) 2022-129924

(51) Int. Cl. G06F 3/0482; G06F 3/04845; G06V 10/25

(52) U.S. Cl. CPC G06F 3/0482; G06F 3/04845; G06V 10/25

(57) ABSTRACT

A control method includes: shifting, when a selection operation for an image displayed on a display screen is received in a first detection region including a display position of the image, the image from an unselected state to a selected state; and executing, when an image operation for the image in the selected state is received in a second detection region, processing corresponding to the image operation on the image in the selected state, the second detection region including the display position and being different from the first detection region.

The present application is based on, and claims priority from JP Application Serial Number 2022-129924, filed Aug. 17, 2022, the disclosure of which is hereby incorporated by reference herein in its entirety.

### BACKGROUND

### 1. Technical Field

The present disclosure relates to a control method, a control device, and a non-transitory computer-readable storage medium storing a program.

### 2. Related Art

A control method of operating an image displayed on a display is known. A control device disclosed in JP-A-2021-44813 receives a selection operation of selecting a grid point that is an image displayed on a display and a change operation of changing a position of the grid point. A grid point to be corrected is selected by the selection operation. The position of the selected grid point is changed by the change operation.

In the above-described JP-A-2021-44813, the selection operation and the change operation for the grid point are disclosed, but a detection region of the selection operation and a detection region of the change operation related to operability of a user are not considered.

### SUMMARY

A control method according to the present disclosure includes: shifting, when a selection operation for an image displayed on a display screen is received in a first detection region including a display position of the image, the image from an unselected state to a selected state; and executing, when an image operation for the image in the selected state is received in a second detection region, processing corresponding to the image operation on the image in the selected state, the second detection region including the display position and being different from the first detection region.

A control device according to the present disclosure includes: one or more processors configured to shift, when a selection operation for an image displayed on a display screen is received in a first detection region including a display position of the image, the image from an unselected state to a selected state, and execute, when an image operation for the image in the selected state is received in a second detection region, processing corresponding to the image operation on the image in the selected state, the second detection region including the display position and being different from the first detection region; and an interface circuit configured to receive the selection operation and the image operation.

A non-transitory computer-readable storage medium stores a program according to the present disclosure, and the program causes a processor of a control device to execute operations including: shifting, when a selection operation for an image displayed on a display screen is received in a first detection region including a display position of the image, the image from an unselected state to a selected state; and executing, when an image operation for the image in the selected state is received in a second detection region, processing corresponding to the image operation on the image in the selected state, the second detection region including the display position and being different from the first detection region.

### BRIEF DESCRIPTION OF THE DRAWINGS

FIG. 1 is a diagram illustrating a schematic configuration of a display system.

FIG. 2 is a diagram illustrating a block configuration of the display system.

FIG. 3 is a diagram illustrating a schematic configuration of a projection unit.

FIG. 4 is a flowchart of geometric distortion correction.

FIG. 5 is a diagram illustrating an outline of a comparison image projected onto a projection surface.

FIG. 6 is a diagram illustrating a configuration of a management screen.

FIG. 7 is a diagram illustrating a configuration of a management screen.

FIG. 8 is a diagram illustrating a schematic configuration when a part of a preview image is displayed in an enlarged manner.

FIG. 9 is a diagram illustrating a schematic configuration when a part of the preview image is displayed in an enlarged manner.

FIG. 10 is a diagram illustrating a schematic configuration when a part of the preview image is displayed in an enlarged manner.

FIG. 11 is a diagram illustrating a flowchart of control of a grid point.

FIG. 12 is a diagram illustrating a schematic configuration when a part of the preview image is displayed in an enlarged manner.

FIG. 13 is a diagram illustrating a schematic configuration when a part of the preview image is displayed in an enlarged manner.

FIG. 14 is a diagram illustrating a schematic configuration when a part of the preview image is displayed in an enlarged manner.

FIG. 15 is a diagram illustrating a schematic configuration when a part of the preview image is displayed in an enlarged manner.

FIG. 16 is a diagram illustrating a configuration of the management screen.

FIG. 17 is a diagram illustrating a configuration of the management screen.

FIG. 18 is a diagram illustrating a schematic configuration when a part of the preview image is displayed in an enlarged manner.

FIG. 19 is a diagram illustrating a schematic configuration when a part of the preview image is displayed in an enlarged manner.

FIG. 20 is a diagram illustrating a configuration of a management screen.

### DESCRIPTION OF EMBODIMENTS

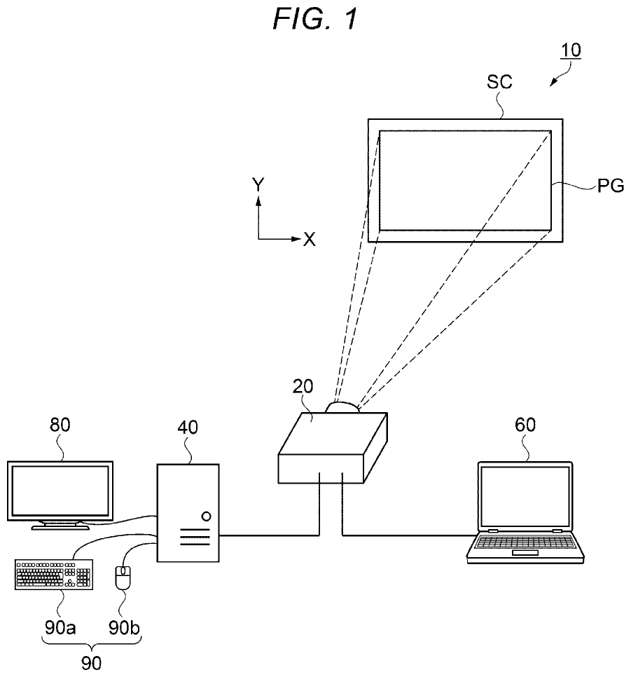

FIG. 1 illustrates a schematic configuration of a display system 10. The display system 10 includes a projector 20, a display control device 40, and an image-providing device 60. The projector 20 projects a projection image PG onto a projection surface SC. The display control device 40 is communicably connected to a display 80 and an input device 90. FIG. 1 illustrates a keyboard 90a and a mouse 90b as the input device 90. The display system 10 illustrated in FIG. 1 includes one projector 20, and is not limited thereto. The display system 10 may include a plurality of projectors 20.

The projector 20 projects various projection images PG onto the projection surface SC. The projector 20 is communicably connected to the display control device 40 and the image-providing device 60. The projector 20 projects the projection image PG onto the projection surface SC based on display data received from the display control device 40 or image data received from the image-providing device 60. The projector 20 corresponds to an example of a projection device.

The display control device 40 generates image correction data for correcting the projection image PG projected by the projector 20. The display control device 40 is communicably connected to the projector 20. The display control device 40 transmits the display data, the image correction data, and the like to the projector 20. The projector 20 projects the projection image PG onto the projection surface SC based on the display data. The projector 20 corrects, based on the image correction data, the projection image PG projected onto the projection surface SC. The display control device 40 corresponds to an example of a control device. The display control device 40 is, for example, a personal computer. The image correction data corresponds to an example of correction data.

The display control device 40 displays various images on the display 80. A user performs an input operation on the image displayed on the display 80. The display control device 40 generates the image correction data by using input data input by the input operation performed by the user.

The image-providing device 60 provides the image data to the projector 20. The image-providing device 60 transmits the image data to the projector 20. The projector 20 projects the image data received from the image-providing device 60 onto the projection surface SC. The projector 20 may correct the image data by using the image correction data received from the display control device 40. The projector 20 projects the image data corrected by the image correction data onto the projection surface SC. The display system 10 illustrated in FIG. 1 includes the image-providing device 60, and is not limited thereto. The display control device 40 may function as the image-providing device 60.

The projection surface SC displays the projection image PG projected by the projector 20. The projection surface SC displays the various projection images PG. The various projection images PG include a comparison image CG to be described later. The comparison image CG is projected onto the projection surface SC based on the display data transmitted from the display control device 40 to the projector 20. The projection surface SC is a surface of an object onto which the projection image PG is projected. The projection surface SC may have a three-dimensional shape such as a surface having unevenness or a curved surface. The projection surface SC may be implemented by a screen or the like. FIG. 1 illustrates an X axis and a Y axis. The X axis and the Y axis are axes on the projection surface SC orthogonal to each other.

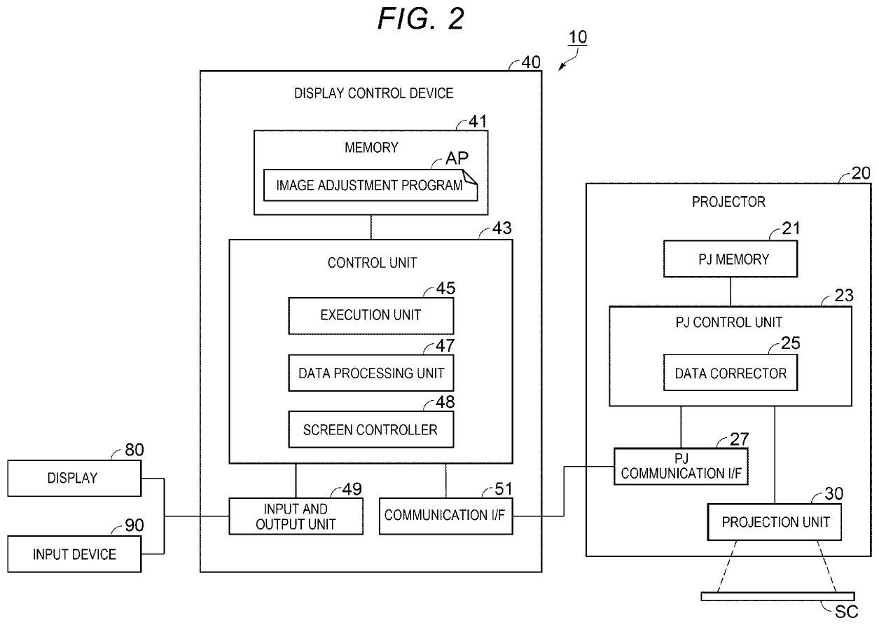

FIG. 2 illustrates a block configuration of the display system 10. In the display system 10 illustrated in FIG. 2, the image-providing device 60 is omitted. FIG. 2 illustrates the projector 20, the display control device 40, the display 80, and the input device 90. FIG. 2 illustrates the projection surface SC onto which the projector 20 projects the projection image PG.

The projector 20 includes a PJ memory 21, a PJ control unit 23, a PJ communication interface 27, and a projection unit 30. In FIG. 2, an interface is represented as an I/F.

The PJ memory 21 stores various types of data. The PJ memory 21 stores the image correction data transmitted from the display control device 40, the display data transmitted from the display control device 40, the image data transmitted from the image-providing device 60, and the like. The PJ memory 21 may store various projector control programs that operate in the PJ control unit 23. The PJ memory 21 includes a read only memory (ROM), a random access memory (RAM), and the like.

The PJ control unit 23 is a projector controller that controls the projector 20. The PJ control unit 23 is, for example, a processor including a central processing unit (CPU). The PJ control unit 23 may be implemented by one or more processors. The PJ control unit 23 may include a semiconductor memory such as an RAM or an ROM. The semiconductor memory functions as a work area of the PJ control unit 23. The PJ control unit 23 functions as a data corrector 25 by executing the projector control program stored in the PJ memory 21.

The data corrector 25 corrects the display data, the image data, and the like. The data corrector 25 performs various types of correction on the display data, the image data, and the like, such as edge blending, geometric distortion correction, and image quality adjustment. The data corrector 25 corrects the image data and the like by using the image correction data stored in the PJ memory 21. The data corrector 25 may divide the image data and the like into unit regions and perform the correction for each unit region.

The PJ communication interface 27 receives various types of data such as the image data, the display data, and the image correction data. The PJ communication interface 27 is communicably connected to an external device such as the display control device 40 and the image-providing device 60. The PJ communication interface 27 is connected to the external device in a wired or wireless manner according to a predetermined communication protocol. The PJ communication interface 27 includes, for example, a wired-communication connecting port, a wireless-communication antenna, and an interface circuit. The PJ communication interface 27 receives the display data, the image correction data, and the like from the display control device 40. The PJ communication interface 27 receives the image data and the like from the image-providing device 60. The PJ communication interface 27 may transmit various types of data to the display control device 40 and the image-providing device 60.

The projection unit 30 projects the projection image PG onto the projection surface SC. The projection unit 30 projects the projection image PG onto the projection surface SC under the control of the PJ control unit 23. A schematic configuration of the projection unit 30 will be described later.

The display control device 40 includes a memory 41, a control unit 43, an input and output unit 49, and a communication interface 51. The display control device 40 is connected to the display 80 and the input device 90 via the input and output unit 49.

The memory 41 stores various types of data, various control programs, and the like. The memory 41 stores the display data, the image correction data, and the like generated by the control unit 43. The memory 41 stores a control program that operates in the control unit 43. The control program stored in the memory 41 includes an image adjustment program AP. The memory 41 includes an ROM, an RAM, and the like. The memory 41 may further include a magnetic storage device such as a hard disk drive (HDD), a semiconductor memory, and the like. The memory 41 corresponds to an example of a storage medium.

The control unit 43 is a controller that performs various types of processing. The control unit 43 generates screen data. The screen data causes the display 80 to display a screen. The control unit 43 generates the image correction data for correcting the projection image PG projected by the projector 20. The control unit 43 transmits comparison image data to the projector 20. The comparison image data is display data for projecting the comparison image CG onto the projection surface SC by the projector 20. The comparison image CG will be described later. The control unit 43 is, for example, a processor including a CPU. The control unit 43 may be implemented by one or more processors. The control unit 43 may include a semiconductor memory such as an RAM or an ROM. The semiconductor memory functions as a work area of the control unit 43. The control unit 43 functions as a functional unit by executing the control program stored in the memory 41. The control unit 43 corresponds to an example of a controller.

The control unit 43 functions as an execution unit 45, a data processing unit 47, and a screen controller 48 by operating the image adjustment program AP stored in the memory 41. The image adjustment program AP causes the display 80 to display a management screen 100. The user corrects the projection image PG projected by the projector 20 by performing an input operation on the management screen 100. The image adjustment program AP generates, based on the input operation performed by the user, the image correction data for correcting the projection image PG. The image adjustment program AP corresponds to an example of a program.

The control unit 43 functions as the execution unit 45, the data processing unit 47, and the screen controller 48 by executing the image adjustment program AP. The execution unit 45, the data processing unit 47, and the screen controller 48 are the functional units. The control unit 43 functions as the functional unit to generate management screen data for displaying the management screen 100 on the display 80. The management screen data is an example of the screen data.

The execution unit 45 performs various types of control based on the input data. The execution unit 45 acquires the input data via the input and output unit 49. The input data is data output by the keyboard 90a and the mouse 90b. The input data includes coordinates of a cursor 200, a click operation signal, and the like.

The execution unit 45 controls a cursor detection region 210. The cursor detection region 210 is a region where the cursor 200 in a display window 141 is detected. The execution unit 45 controls an area, a shape, and the like of the cursor detection region 210 when acquiring the input data. The execution unit 45 may control the cursor detection region 210 when an interval between adjacent grid lines 145 or an interval between adjacent grid points 147 is changed. The display window 141, the cursor detection region 210, the grid line 145, and the grid point 147 will be described later.

The execution unit 45 generates the comparison image data to be transmitted to the projector 20. The comparison image data causes the projector 20 to project the comparison image CG onto the projection surface SC. The comparison image data will be described later. The execution unit 45 transmits the generated comparison image data to the communication interface 51.

The execution unit 45 executes various types of processing on the grid line 145 and the grid point 147. The execution unit 45 executes the various types of processing on the grid line 145 or the grid point 147 based on the input data. Examples of the various types of processing include selection processing, selection release processing, lock processing, lock release processing, and movement processing. When executing the various types of processing, the execution unit 45 generates user setting data including processing results of the various types of processing. The execution unit 45 transmits the generated user setting data to the data processing unit 47. The execution unit 45 corresponds to an example of the controller.

The data processing unit 47 generates the image correction data for correcting the projection image PG. The data processing unit 47 generates the image correction data based on the user setting data received from the execution unit 45. The data processing unit 47 transmits the generated image correction data to the communication interface 51. The data processing unit 47 may transmit the generated image correction data to the memory 41. The memory 41 stores the received image correction data.

The image correction data is data for performing the various types of correction such as the geometric distortion correction. The geometric distortion correction is processing of correcting a distortion of the projection image PG. The distortion of the projection image PG occurs when the projection surface SC is a curved surface or when the projection surface SC has unevenness. The distortion of the projection image PG occurs when the projector 20 projects the projection image PG from a position other than front of the projection surface SC. The image correction data is generated based on the input data input by the input operation performed by the user. The image correction data is used for adjusting the distortion of the projection image PG projected onto the projection surface SC.

The screen controller 48 generates the screen data to be displayed on the display 80. The screen controller 48 transmits the generated screen data to the display 80 via the input and output unit 49. The screen controller 48 displays a screen based on the screen data on the display 80. The screen data is changed based on the user setting data generated by the execution unit 45. When the screen data is changed, the screen controller 48 transmits the changed screen data to the display 80. The screen controller 48 changes a screen displayed on the display 80 by transmitting the changed screen data to the display 80.

The input and output unit 49 is connected to various devices such as the display 80 and the input device 90, and transmits and receives various types of data to and from the various devices. The input and output unit 49 is an input and output interface connected to the various devices, and includes an interface circuit. The input and output unit 49 includes one or more connecting ports such as a communication port and a display port of a universal serial bus (USB) standard. The input and output unit 49 illustrated in FIG. 2 is connected to the display 80 and the input device 90. The input and output unit 49 transmits the screen data to the display 80. The input and output unit 49 receives the input data output from the input device 90. The input and output unit 49 receives the screen data generated by the screen controller 48 and transmits the screen data to the display 80. The input and output unit 49 transmits the received input data to the execution unit 45. The input and output unit 49 corresponds to an example of a receiver.

The input data is data corresponding to the input operation. The input data is output when the user performs the input operation by using the input device 90. The input data is an operation signal output when the user performs various input operations by using the input device 90. The operation signal is a click signal, a double-click signal, a drag signal, or the like. The input data includes coordinate information. The coordinate information is position information on a cursor tip 200a when the user performs the input operation. The cursor tip 200a will be described later.

The communication interface 51 is communicably connected to an external device such as the projector 20. The communication interface 51 is connected to the external device in a wired or wireless manner according to a predetermined communication protocol. The communication interface 51 illustrated in FIG. 2 is communicably connected to the PJ communication interface 27 of the projector 20. The communication interface 51 includes, for example, a wired-communication connecting port, a wireless-communication antenna, and an interface circuit. The communication interface 51 receives the comparison image data from the execution unit 45. The communication interface 51 transmits the received comparison image data to the projector 20. The communication interface 51 receives the image correction data from the data processing unit 47. The communication interface 51 transmits the received image correction data to the projector 20. The communication interface 51 may receive various types of data transmitted from the projector 20.

The display 80 displays the screen based on the screen data transmitted from the display control device 40. The display 80 is connected to the input and output unit 49. The display 80 displays the management screen 100 based on the management screen data transmitted from the display control device 40. The display 80 displays the cursor 200 that moves based on the input operation input to the input device 90 by the user. The display 80 receives, via the input and output unit 49, the input data based on the input operation performed by the user. The display 80 is constituted by a display panel such as a liquid crystal panel or an organic electro-luminescence (EL) panel. The display 80 may receive the input data from the input device 90. The display 80 corresponds to an example of a display screen. The cursor 200 corresponds to an example of an instruction image. The display 80 may be any device as long as the device can display a screen based on the screen data transmitted from the display control device 40, and a direct-view display device or a projection-type display device may be used.

The input device 90 receives the input operation performed by the user. The input device 90 generates the input data based on the input operation performed by the user. The input device 90 transmits the generated input data to the input and output unit 49. The input device 90 may transmit the generated input data to the display 80. The input device 90 is implemented by one or more devices. The input device 90 illustrated in FIG. 1 is implemented by the keyboard 90a and the mouse 90b. The input device 90 is not limited to the keyboard 90a and the mouse 90b. The input device 90 may be implemented by a liquid crystal pen tablet, a pointer, or the like.

In the display system 10 illustrated in FIG. 2, the display 80 and the input device 90 are connected to the display control device 40, but the configuration thereof is not limited thereto. The display 80 may have a touch input function. When the display 80 has the touch input function, the display 80 functions as the input device 90. The display 80 and the input device 90 illustrated in FIG. 2 are separated from the display control device 40, but are not limited thereto. At least one of the display 80 and the input device 90 may be integrated with the display control device 40.

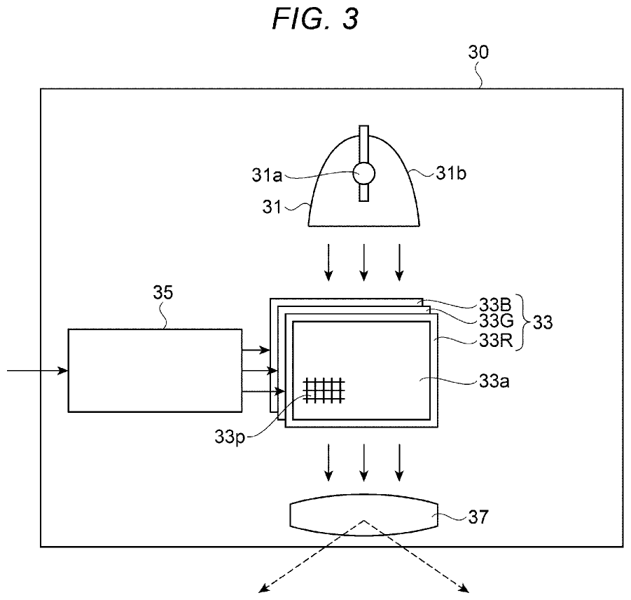

FIG. 3 illustrates a schematic configuration of the projection unit 30. FIG. 3 illustrates an example of the projection unit 30. The projection unit 30 includes a light source 31, three liquid crystal light valves 33, a light valve driver 35, and a projection lens 37.

The light source 31 emits light to the liquid crystal light valve 33. The light source 31 includes a light source unit 31a, a reflector 31b, an integrator optical system (not illustrated), and a color separation optical system (not illustrated). The light source unit 31a emits the light. The light source unit 31a is implemented by a xenon lamp, an ultra-high pressure mercury lamp, a light emitting diode (LED), a laser light source, or the like. The light source 31 emits the light under the control of the PJ control unit 23. The reflector 31b reduces a variation in an emission direction of the light emitted by the light source unit 31a. The integrator optical system reduces a variation in a luminance distribution of the light emitted by the light source 31. The light passing through the reflector 31b enters the color separation optical system. The color separation optical system separates the entered light into red, green, and blue light components.

The liquid crystal light valve 33 modulates the light emitted by the light source 31. The liquid crystal light valve 33 generates the projection image PG by modulating the light. The liquid crystal light valve 33 is implemented by, for example, a liquid crystal panel in which liquid crystal is sealed between a pair of transparent substrates. The liquid crystal light valve 33 includes a rectangular pixel region 33a including a plurality of pixels 33p arranged in a matrix. In the liquid crystal light valve 33, a drive voltage is applied to the liquid crystal for each pixel 33p. The projection unit 30 illustrated in FIG. 3 includes the three liquid crystal light valves 33. The projection unit 30 includes the liquid crystal light valves 33, but is not limited thereto. The projection unit 30 may include one or more digital mirror devices (DMDs).

The three liquid crystal light valves 33 include a red-light liquid crystal light valve 33R, a green-light liquid crystal light valve 33G, and a blue-light liquid crystal light valve 33B. The red light component separated by the color separation optical system is incident on the red-light liquid crystal light valve 33R. The green light component separated by the color separation optical system is incident on the green-light liquid crystal light valve 33G. The blue light component separated by the color separation optical system is incident on the blue-light liquid crystal light valve 33B.

The light valve driver 35 applies the drive voltage to each pixel 33p based on the image data received from the PJ control unit 23. The light valve driver 35 is, for example, a control circuit. The drive voltage is supplied by a drive source (not illustrated). The light valve driver 35 may apply the drive voltage to each pixel 33p based on the image data corrected by the data corrector 25. When the light valve driver 35 applies the drive voltage to each pixel 33p, each pixel 33p is set to a light transmittance based on the image data. The light emitted from the light source 31 is modulated by passing through the pixel region 33a. The three liquid crystal light valves 33 form color component images for each color light.

The projection lens 37 synthesizes the color component images formed by the liquid crystal light valves 33 and projects a synthesized image in an enlarged manner. The projection lens 37 projects the projection image PG onto the projection surface SC. The projection image PG is a multicolor image obtained by synthesizing the color component images.

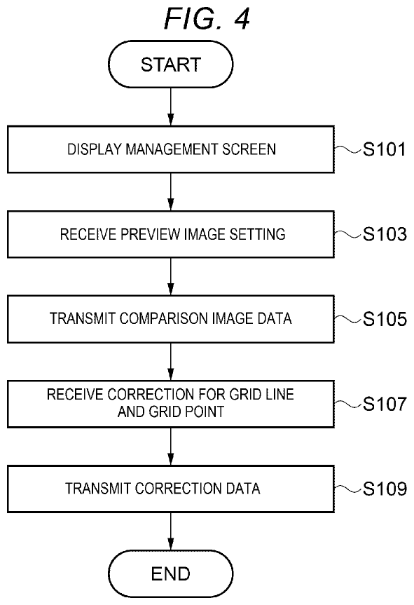

The display control device 40 can allow the user to correct the projection image PG projected onto the projection surface SC by the projector 20. FIG. 4 illustrates a flowchart of the geometric distortion correction. FIG. 4 illustrates a correction procedure of the geometric distortion correction executed in the display control device 40. The user can correct the projection image PG projected onto the projection surface SC by performing the input operation by using the input device 90.

In step S101, the display control device 40 displays the management screen 100 on the display 80. Details of the management screen 100 will be described later. When the user causes the image adjustment program AP to be executed, the display control device 40 displays the management screen 100 on the display 80. The management screen 100 is one of a plurality of screens displayed when the image adjustment program AP is executed. When the user performs an input operation of designating the display of the management screen 100, the management screen 100 may be displayed on the display 80.

After the management screen 100 is displayed on the display 80, in step S103, the display control device 40 receives a preview image setting performed by the user. The preview image setting is an example of the input data. When the user performs the input operation by using the input device 90, the display control device 40 receives the preview image setting. The preview image setting is the number of grid lines 145 or the number of grid points 147. In the preview image setting, for example, the number of grid points 147 in a vertical direction and the number of grid points 147 in a horizontal direction are set. The vertical direction indicates an up-down direction of the management screen 100. The horizontal direction indicates a left-right direction of the management screen 100.

After receiving the preview image setting, in step S105, the display control device 40 transmits the comparison image data to the projector 20. The display control device 40 generates the comparison image data based on the set preview image setting. The display control device 40 transmits the generated comparison image data to the projector 20. The projector 20 receives the comparison image data, and projects the comparison image CG based on the received comparison image data onto the projection surface SC.

The display control device 40 may transmit the preview image setting to the projector 20. When the display control device 40 transmits the preview image setting to the projector 20, the projector 20 generates the comparison image data. The projector 20 generates the comparison image data by using the preview image setting. The projector 20 projects the comparison image CG based on the generated comparison image data onto the projection surface SC.

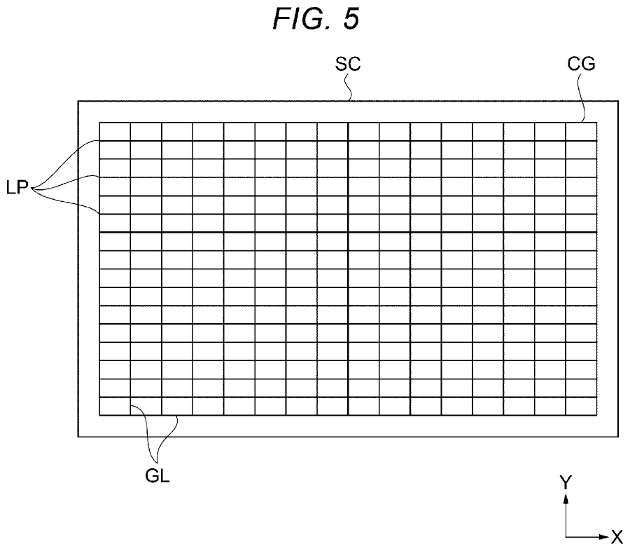

FIG. 5 illustrates an outline of the comparison image CG projected onto the projection surface SC. FIG. 5 illustrates an example of the comparison image CG. The comparison image CG illustrated in FIG. 5 is the projection image PG when 17 grid points 147 in the vertical direction and 17 grid points 147 in the horizontal direction are set in the preview image setting. The comparison image CG is an example of the projection image PG. The horizontal direction of the preview image setting corresponds to the X axis of the projection surface SC. The vertical direction of the preview image setting corresponds to the Y axis of the projection surface SC.

The comparison image CG includes a plurality of comparison grid lines GL and a plurality of comparison grid points LP. The plurality of comparison grid lines GL include the comparison grid lines GL extending along the X axis and the comparison grid lines GL extending along the Y axis. The comparison grid lines GL extending along the X axis are arranged at predetermined intervals along the Y axis. The comparison grid lines GL extending along the Y axis are arranged at predetermined intervals along the X axis. The comparison grid point LP is an intersection of the comparison grid line GL extending along the X axis and the comparison grid line GL extending along the Y axis. The plurality of comparison grid points LP are arranged along the X axis and the Y axis. The user checks the comparison grid lines GL or the comparison grid points LP in the comparison image CG and corrects the projection image PG.

When the projection surface SC is a smooth surface, the plurality of comparison grid lines GL and the plurality of comparison grid points LP are evenly arranged along the X axis and the Y axis as illustrated in FIG. 5. When the projection surface SC has unevenness, for example, the comparison grid line GL and the comparison grid point LP projected at a position of the unevenness are projected at uneven positions different from positions at which the comparison grid line GL and the comparison grid point LP are evenly arranged. The user checks the comparison grid line GL or the comparison grid point LP projected to the uneven position as a correction point.

After projecting the comparison image CG by the projector 20, the display control device 40 receives correction for the grid line 145 or for the grid point 147 in step S107 illustrated in FIG. 4. The display control device 40 displays a preview image 143 corresponding to the preview image setting set in step S103 on the display 80. The preview image 143 is displayed on the management screen 100. The user checks the grid line 145 or the grid point 147 in the preview image 143 corresponding to the correction point as a target point. When the user performs an input operation of moving the target point with the input device 90, the display control device 40 receives the correction for the grid line 145 or for the grid point 147 which is the target point.

After receiving the correction for the grid line 145 or for the grid point 147 which is the target point, in step S109, the display control device 40 transmits the image correction data to the projector 20. The display control device 40 generates the image correction data based on the correction for the grid line 145 or for the grid point 147 which is the target point. The display control device 40 transmits the generated image correction data to the projector 20.

The projector 20 receives the image correction data. The projector 20 corrects the comparison image data by using the image correction data. The projector 20 projects the comparison image CG onto the projection surface SC based on the corrected comparison image data. The user checks the comparison image CG projected based on the comparison image data corrected by the image correction data.

The user checks whether the comparison grid lines GL or the comparison grid points LP included in the comparison image CG projected onto the projection surface SC are arranged at the predetermined intervals along the X axis and the Y axis. When the user determines that the comparison grid lines GL or the comparison grid points LP are arranged at the predetermined intervals, the user ends a correction processing operation. When the user determines that the comparison grid lines GL or the comparison grid points LP are not arranged at the predetermined intervals, the user performs the input operation of moving the grid line 145 or the grid point 147. When the user performs the input operation, the display control device 40 receives the correction for the grid line 145 or for the grid point 147 which is the target point illustrated in step S107. The display control device 40 generates image correction data again based on the received correction for the grid line 145 or for the grid point 147. The display control device 40 transmits the regenerated image correction data to the projector 20. When the user performs the input operation of moving the grid line 145 or the grid point 147, the display control device 40 repeatedly executes step S107 and step S109.

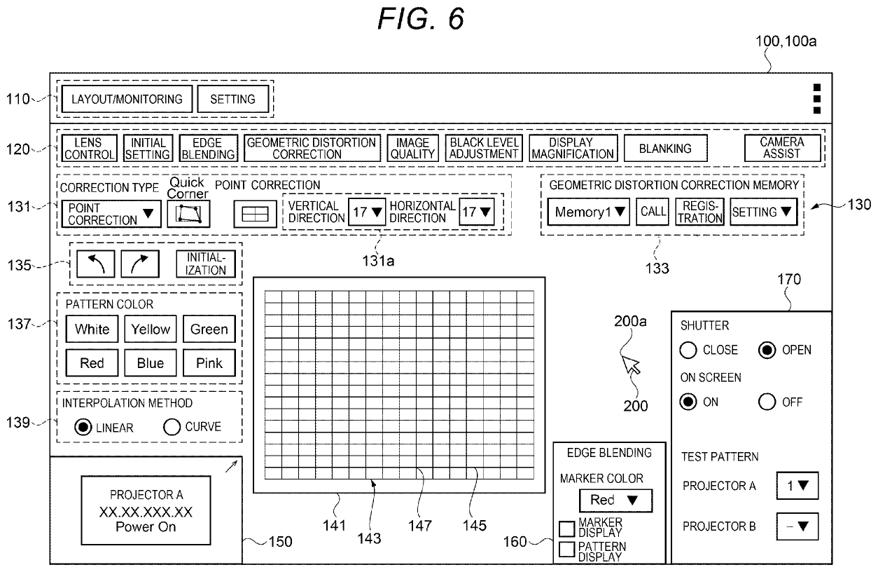

FIG. 6 illustrates a configuration of the management screen 100. The management screen 100 is displayed on the display 80 under the control of the display control device 40. The management screen 100 is displayed on the display 80 when the display control device 40 executes the image adjustment program AP. The management screen 100 illustrated in FIG. 6 is a screen displayed when the geometric distortion correction is performed. FIG. 6 illustrates a first management screen 100a as an example of the management screen 100.

The first management screen 100a includes a basic setting region 110, a tab region 120, a geometric distortion correction region 130, a sub-window display region 150, an edge blending region 160, and a projector setting region 170. The sub-window display region 150, the edge blending region 160, and the projector setting region 170 are displayed on the geometric distortion correction region 130 in a superimposed manner.

The basic setting region 110 displays a layout/monitoring tab and a setting tab. When the layout/monitoring tab is selected by the input operation of the user, a layout/monitoring region is displayed on the first management screen 100a. When the setting tab is selected by the input operation of the user, a setting region is displayed on the first management screen 100a.

In the layout/monitoring region, a state of the projector 20 connected to the display control device 40 is displayed. The layout/monitoring region is not illustrated. The display control device 40 can be connected to the plurality of projectors 20. When the display control device 40 is connected to the projector 20, the state of the projector 20 is displayed in the layout/monitoring region. The state of the projector 20 includes a power ON/OFF state, a connected state including a network address, an error occurrence state, and the like. When the plurality of projectors 20 are connected to the display control device 40, layouts of the plurality of projectors 20 are displayed in the layout/monitoring region.

The setting region is a region where various settings are performed. When the user selects one of a plurality of tabs displayed in the tab region 120 by the input operation, a region corresponding to the selected tab is displayed on the first management screen 100a. In the first management screen 100a illustrated in FIG. 6, the geometric distortion correction region 130 for setting the geometric distortion correction is shown.

In the tab region 120, a lens control tab, an initial setting tab, an edge blending tab, a geometric distortion correction tab, an image quality tab, a black level adjustment tab, a display magnification tab, a blanking tab, and a camera assist tab are displayed.

When the lens control tab is selected by the input operation of the user, a lens control setting region is displayed on the first management screen 100a. The lens control setting region is not illustrated. In the lens control setting region, various icons for controlling a lens of the projector 20 are displayed. The user adjusts a focus of the lens by performing an input operation on the various icons displayed in the lens control setting region.

When the initial setting tab is selected by the input operation of the user, an initial setting region is displayed on the first management screen 100a. The initial setting region is not illustrated. In the initial setting region, various icons related to a setting of the projector 20 are displayed. The user performs various initial settings by performing an input operation on the various icons displayed in the initial setting region. The initial settings include calibration of the light source 31, a brightness level, initialization of the PJ memory 21, and the like.

When the edge blending tab is selected by the input operation of the user, an edge blending setting region is displayed on the first management screen 100a. The edge blending setting region is not illustrated. The edge blending setting region is displayed, based on the control of the display control device 40, when a single projection image PG is created by the plurality of projectors 20. In the edge blending setting region, various icons for adjusting the projection image PG are displayed. The user adjusts a range where a plurality of the projection images PG constituting the single projection image PG are overlapped by performing an input operation on the various icons displayed in the edge blending setting region.

When the image quality tab is selected by the input operation of the user, an image quality setting region is displayed on the first management screen 100a. The image quality setting region is not illustrated. In the image quality setting region, various icons related to an image quality setting of the projection image PG are displayed. The user performs the image quality setting by performing an input operation on the various icons displayed in the image quality setting region. The image quality setting to be set includes color matching, brightness, contrast, frame interpolation, and the like.

When the black level adjustment tab is selected by the input operation of the user, a black level adjustment region is displayed on the first management screen 100a. The black level adjustment region is not illustrated. In the black level adjustment region, various icons related to black level adjustment of the projection images PG projected onto the projection surface SC by the plurality of projectors 20 are displayed. The user performs the black level adjustment by performing an input operation on the various icons displayed in the black level adjustment region. The black level adjustment is adjustment of brightness, a color tone, and the like of a portion where images do not overlap.

When the display magnification tab is selected by the input operation of the user, a display magnification setting region is displayed on the first management screen 100a. The display magnification setting region is not illustrated. In the display magnification setting region, various icons related to a display magnification of the projection image PG are displayed. The user performs a display magnification setting by performing an input operation on the various icons displayed in the display magnification setting region. The display magnification setting is a magnification setting when a part of the projection image PG is enlarged.

When the blanking tab is selected by the input operation of the user, a blanking setting region is displayed on the first management screen 100a. The blanking setting region is not illustrated. In the blanking setting region, various icons related to a setting of the projection image PG are displayed. The user performs a blanking setting by performing an input operation on the various icons displayed in the blanking setting region. The blanking setting is a setting for hiding a specific region of the projection image PG.

When the camera assist tab is selected by the input operation of the user, a camera assist adjustment region is displayed on the first management screen 100a. The camera assist adjustment region is not illustrated. In the camera assist adjustment region, various icons for executing automatic adjustment of the projection image PG by using, for example, a camera provided in the projector 20 are displayed. The user executes various types of automatic adjustment on the projection image PG by performing an input operation on the various icons displayed in the camera assist adjustment region. The automatic adjustment for the projection image PG includes screen matching, color calibration, tiling, and the like.

When the geometric distortion correction tab is selected by the input operation of the user, the geometric distortion correction region 130 illustrated in FIG. 6 is displayed on the first management screen 100a. In the geometric distortion correction region 130, various icons related to the geometric distortion correction are displayed. In the geometric distortion correction region 130, a correction setter 131, a file setter 133, an operation instructor 135, a color setter 137, a method setter 139, and the display window 141 are displayed.

The correction setter 131 displays various icons related to a setting of a correction type, a correction type display field for displaying a selected correction type, and a preview image setting field 131a. The correction type to be selected includes curved surface projection correction, corner projection correction, point correction, and curve correction. The preview image setting illustrated in step S103 of FIG. 4 is received in the preview image setting field 131a. The preview image setting field 131a illustrated in FIG. 6 receives the number of grid points 147 in the vertical direction and the number of grid points 147 in the horizontal direction.

The file setter 133 displays various icons for receiving an instruction related to a setting file. The setting file includes a distortion correction setting set in the geometric distortion correction region 130. The user instructs storage of the setting file in the memory 41 by performing an input operation on the various icons displayed in the file setter 133.

The operation instructor 135 displays various icons for controlling the input operation performed by the user in the geometric distortion correction region 130. The user cancels an input operation input immediately before by performing an input operation on the various icons displayed in the operation instructor 135.

The color setter 137 displays a plurality of icons related to designation of a color of the grid line 145 or a color of the grid point 147 displayed in the display window 141. When the user performs an input operation on one icon among the plurality of icons displayed in the color setter 137, the color of the grid line 145 or the color of the grid point 147 displayed in the display window 141 is changed.

The method setter 139 displays selection buttons for selecting an interpolation method between the grid points 147. In the method setter 139 illustrated in FIG. 6, linear interpolation or curve interpolation can be selected. The interpolation method is a position correction method between the adjacent grid points 147.

The display window 141 displays the preview image 143. The preview image 143 corresponds to the comparison image CG projected onto the projection surface SC by the projector 20. The preview image 143 includes the grid lines 145 and the grid points 147. The preview image 143 is displayed based on the screen data. The screen data is generated by the screen controller 48 by using default screen data stored in the memory 41. The default screen data includes the predetermined number of grid lines 145 and a predetermined interval between the grid lines 145, or the predetermined number of grid points 147 and a predetermined interval between the grid points 147. The number of grid points 147 included in the default screen data is corrected by a value input into the preview image setting field 131a. The screen data includes the number of grid points 147 corrected based on the value input into the preview image setting field 131a. The display window 141 displays the entire preview image 143.

The screen data generated by the screen controller 48 is transmitted to the display 80 by the input and output unit 49. The display 80 receives the screen data. The display 80 displays the preview image 143 in the display window 141 based on the received screen data. The display control device 40 displays the preview image 143 on the display 80 based on the screen data.

The preview image 143 includes the plurality of grid lines 145 and the plurality of grid points 147. The plurality of grid lines 145 include the grid lines 145 extending along a vertical axis of the display window 141 and the grid lines 145 extending along a horizontal axis of the display window 141. The plurality of grid lines 145 extending along the vertical axis are arranged at the predetermined intervals along the horizontal axis of the display window 141. The plurality of grid lines 145 extending along the horizontal axis are arranged at the predetermined intervals along the vertical axis of the display window 141. The grid point 147 is an intersection of the grid line 145 extending along the vertical axis of the display window 141 and the grid line 145 extending along the horizontal axis of the display window 141. The grid points 147 are arranged at the predetermined intervals along the vertical axis of the display window 141. The number of grid points 147 arranged along the vertical axis of the display window 141 is the same as a value in the vertical direction set in the preview image setting field 131a. The grid points 147 are arranged at the predetermined intervals along the horizontal axis of the display window 141. The number of grid points 147 arranged along the horizontal axis of the display window 141 is the same as a value in the horizontal direction set in the preview image setting field 131a. The grid line 145 and the grid point 147 correspond to examples of the image.

In the sub-window display region 150, a region different from the geometric distortion correction region 130 is displayed. In the sub-window display region 150, for example, the layout/monitoring region or a part of the layout/monitoring region may be displayed. When the user performs the input operation on the sub-window display region 150, the region displayed in the sub-window display region 150 is switched to the geometric distortion correction region 130 and displayed on the first management screen 100a.

In the edge blending region 160, a selection button for receiving an input operation related to the edge blending is displayed. The edge blending region 160 is used when the geometric distortion correction is performed on the projection images PG projected by the plurality of projectors 20 onto the projection surface SC.

In the projector setting region 170, a selection button for receiving an input operation related to the setting of the projector 20 is displayed. The projector setting region 170 is used when the display control device 40 is connected to one or more projectors 20. For example, when selecting the projector 20 that projects the comparison image CG onto the projection surface SC, the user performs the input operation on the selection button displayed in the projector setting region 170.

The management screen 100 displays the cursor 200. The cursor 200 is moved by a cursor movement operation of the user. The cursor movement operation is an example of the input operation. When the user performs the cursor movement operation by using the input device 90 such as the mouse 90b, the cursor 200 is moved on the management screen 100. The cursor 200 is movable to any grid line 145 or any grid point 147. The user uses the cursor 200 when performing the cursor movement operation on any grid line 145 or any grid point 147 or the input operation on the grid point 147, and the like. The cursor 200 is operated when the user performs the cursor movement operation by using the input device 90.

The cursor 200 illustrated in FIG. 6 has an arrow shape. A shape of the cursor 200 is not limited to the arrow shape. The shape of the cursor 200 can be appropriately selected from a cross shape, a circular shape, and the like. The cursor tip 200a of the arrow-shaped cursor 200 indicates a position instructed by the user. The instruction position is appropriately changed according to the shape of the cursor 200. When the shape of the cursor 200 is, for example, a cross shape, a center position of the cursor 200 is the position instructed by the user.

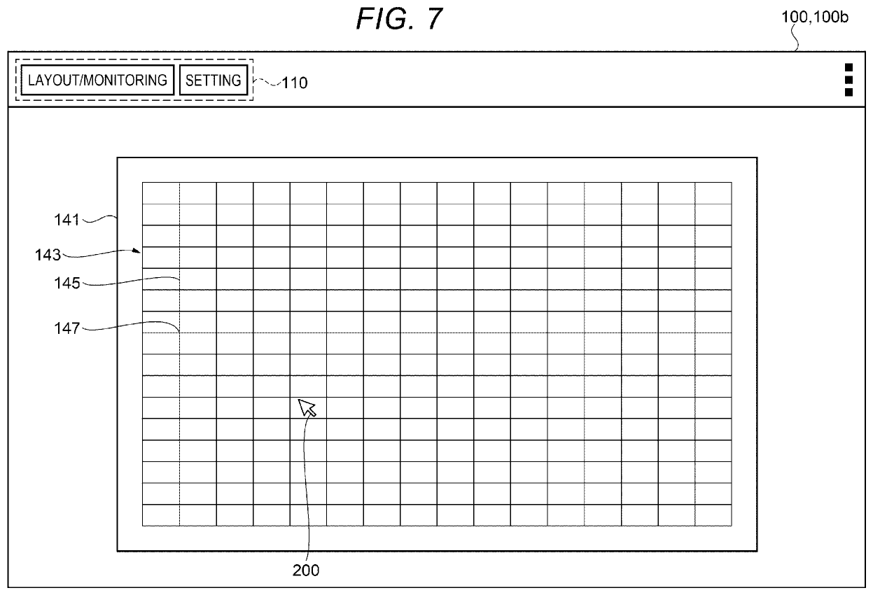

FIG. 7 illustrates a configuration of the management screen 100. FIG. 7 illustrates a second management screen 100b as an example of the management screen 100. The second management screen 100b is displayed on the display 80 under the control of the display control device 40. The second management screen 100b is displayed on the display 80 when the display control device 40 executes the image adjustment program AP. The second management screen 100b is a screen displayed when the geometric distortion correction is performed.

The second management screen 100b displays the display window 141 in an enlarged manner. When the user performs a predetermined input operation, the first management screen 100a is switched to the second management screen 100b. The user can appropriately switch between the first management screen 100a and the second management screen 100b. The display window 141 is displayed on the second management screen 100b in an enlarged manner, and thus the user easily recognizes the preview image 143 visually. The second management screen 100b displays the basic setting region 110 and the display window 141, but is not limited thereto. The second management screen 100b may display the tab region 120. The second management screen 100b may display a part of configurations such as the correction setter 131 displayed in the geometric distortion correction region 130.

### First Embodiment

A first embodiment discloses control of the cursor detection region 210 when the grid point 147 is shifted from a grid point unselected state to a grid point selected state. The grid point unselected state corresponds to an example of an unselected state. The grid point selected state corresponds to an example of a selected state. The first embodiment discloses control in which a first cursor detection region 210a in the grid point unselected state is set to be narrower than a second cursor detection region 210b in the grid point selected state. The first cursor detection region 210a and the second cursor detection region 210b are examples of the cursor detection region 210. The first cursor detection region 210a corresponds to an example of a first detection region. The second cursor detection region 210b corresponds to an example of a second detection region.

FIG. 8 illustrates a schematic configuration when a part of the preview image 143 is displayed in an enlarged manner. FIG. 8 illustrates a configuration in which any range in the preview image 143 is enlarged. FIG. 8 illustrates the plurality of grid lines 145, the plurality of grid points 147, and the cursor 200. The grid lines 145 extending along the vertical axis are arranged at a first inter-vertical-line distance Vd1. The grid lines 145 extending along the horizontal axis are arranged at a first inter-horizontal-line distance Hd1. The grid point 147 illustrated in FIG. 8 is in the grid point unselected state, which means the grid point 147 is not selected by the input operation of the user.

FIG. 8 illustrates the first cursor detection region 210a of a first grid point 147a which is one of the plurality of grid points 147. The first grid point 147a illustrated in FIG. 8 is in the grid point unselected state. The first cursor detection region 210a is controlled by the execution unit 45. The first cursor detection region 210a is set to include a first position P1 where the first grid point 147a is displayed. The first position P1 corresponds to an example of a display position.

When the user moves the cursor tip 200a into the first cursor detection region 210a, the first grid point 147a is selectable. When the user performs a grid point selection operation with the input device 90, the first grid point 147a in the first cursor detection region 210a is selected. The first cursor detection region 210a is a region where the grid point selection operation for the first grid point 147a can be received. The selected first grid point 147a is shifted from the grid point unselected state to the grid point selected state. The grid point selection operation is, for example, a click operation using the mouse 90b. The grid point selection operation may be a click operation on the mouse 90b in a state where the user presses a predetermined key in the keyboard 90a. The grid point selection operation is set in advance. When the grid point selection operation is performed by the user, input data corresponding to the grid point selection operation is transmitted from the input device 90 to the input and output unit 49. The input data corresponding to the grid point selection operation includes coordinate information on the cursor tip 200a when the grid point selection operation is performed. The input and output unit 49 receives the input data corresponding to the grid point selection operation. The grid point selection operation corresponds to an example of a selection operation.

The input and output unit 49 transmits the received input data corresponding to the grid point selection operation to the execution unit 45. The execution unit 45 receives the input data corresponding to the grid point selection operation. The execution unit 45 acquires the coordinate information included in the input data corresponding to the grid point selection operation. The execution unit 45 determines, based on the acquired coordinate information, the grid point 147 on which the grid point selection operation is performed. When the execution unit 45 determines that the grid point 147 on which the grid point selection operation is performed is the first grid point 147a, the execution unit 45 shifts the first grid point 147a from the grid point unselected state to the grid point selected state. The execution unit 45 changes the cursor detection region 210 of the first grid point 147a from the first cursor detection region 210a to the second cursor detection region 210b. The second cursor detection region 210b is different from the first cursor detection region 210a.

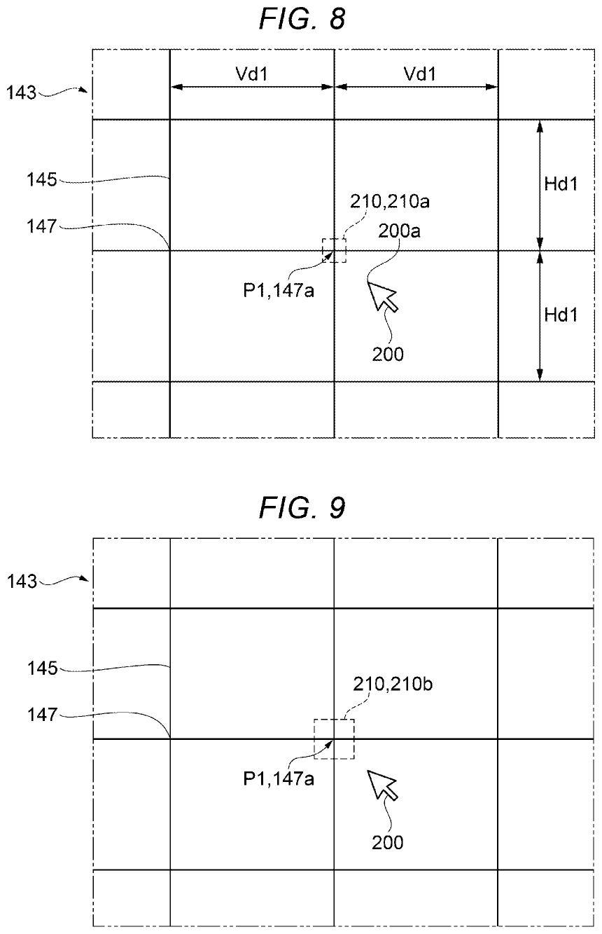

FIG. 9 illustrates a schematic configuration when a part of the preview image 143 is displayed in an enlarged manner. FIG. 9 illustrates a configuration in which any range in the preview image 143 is enlarged. FIG. 9 illustrates the plurality of grid lines 145, the plurality of grid points 147, and the cursor 200. In FIG. 9, the first inter-vertical-line distance Vd1 and the first inter-horizontal-line distance Hd1 are omitted. The first grid point 147a illustrated in FIG. 9 is in the grid point selected state. The grid points 147 other than the first grid point 147a are in the grid point unselected state.

FIG. 9 illustrates the second cursor detection region 210b of the first grid point 147a in the grid point selected state. The second cursor detection region 210b is controlled by the execution unit 45. The second cursor detection region 210b is set to include the first position P1 where the first grid point 147a is displayed. The second cursor detection region 210b is set to be wider than the first cursor detection region 210a. The second cursor detection region 210b is the cursor detection region 210 where a grid point operation for the first grid point 147a can be received. By setting the second cursor detection region 210b to be wider than the first cursor detection region 210a, the user can easily perform the input operation on the first grid point 147a in the grid point selected state.

When the user moves the cursor tip 200a to the second cursor detection region 210b of the first grid point 147a, the grid point operation for the first grid point 147a can be received. The second cursor detection region 210b is a region where the grid point operation for the first grid point 147a can be received. When the user performs the grid point operation by using the input device 90, the grid point operation for the first grid point 147a in the second cursor detection region 210b is executed.

The grid point operation is, for example, a drag operation using the mouse 90b. The grid point operation may be a double-click operation using the mouse 90b. The grid point operation may be a click operation using the mouse 90b. The grid point operation may be a control drag operation on the mouse 90b in a state where the user presses a predetermined key in the keyboard 90a. The grid point operation is set in advance. The drag operation corresponds to, for example, a movement operation for the first grid point 147a. The double-click operation corresponds to a lock operation for the first grid point 147a. The lock operation is an operation of disabling the input operation for the first grid point 147a. The click operation corresponds to a selection release operation. The selection release operation is an operation of shifting the first grid point 147a from the grid point selected state to the grid point unselected state. The control drag operation is a fine adjustment operation. The fine adjustment operation is an operation of finely adjusting a position of the first grid point 147a. A correlation between the grid point operation and the input operation is appropriately set. The grid point operation corresponds to an example of an image operation.

When the grid point operation is performed by the user, input data corresponding to the grid point operation is transmitted from the input device 90 to the input and output unit 49. The input data corresponding to the grid point operation includes coordinate information on the cursor tip 200a when the grid point operation is performed. The input and output unit 49 receives the input data corresponding to the grid point operation.

The input and output unit 49 transmits the received input data corresponding to the grid point operation to the execution unit 45. The execution unit 45 receives the input data corresponding to the grid point operation. The execution unit 45 acquires the coordinate information included in the input data corresponding to the grid point operation. The execution unit 45 determines, based on the acquired coordinate information, the grid point 147 on which the grid point operation is performed. When the execution unit 45 determines that the grid point 147 on which the grid point operation is performed is the first grid point 147a, the execution unit 45 executes grid point processing on the first grid point 147a. The grid point processing corresponds to the grid point operation.

FIG. 10 illustrates a schematic configuration when a part of the preview image 143 is displayed in an enlarged manner. FIG. 10 illustrates a configuration in which any range in the preview image 143 is enlarged. FIG. 10 illustrates the plurality of grid lines 145, the plurality of grid points 147, and the cursor 200. In FIG. 10, the first inter-vertical-line distance Vd1 and the first inter-horizontal-line distance Hd1 are omitted. The first grid point 147a illustrated in FIG. 10 is in a state where the grid point processing corresponding to the grid point operation is executed. The grid points 147 other than the first grid point 147a are in a state where the grid point processing corresponding to the grid point operation is not executed.

The first grid point 147a illustrated in FIG. 10 is moved to a second position P2 different from the first position P1 which is the position of the first grid point 147a illustrated in FIG. 9. FIG. 10 illustrates a state where the movement processing corresponding to the movement operation is executed on the first grid point 147a. The movement processing is an example of the grid point processing. By the movement processing, the first grid point 147a is moved from the first position P1 to the second position P2. The grid point processing corresponds to an example of processing corresponding to the image operation. When the drag operation is performed while the cursor tip 200a is located in the second cursor detection region 210b, the first grid point 147a is moved from the first position P1 to the second position P2 in response to the drag operation. When the movement operation is received in the second cursor detection region 210b, the movement processing of moving the first grid point 147a is executed. The first position P1 corresponds to the example of the display position. The second position P2 corresponds to an example of the movement position.

When the first grid point 147a is moved from the first position P1 to the second position P2, the execution unit 45 transmits position information on the second position P2 to the data processing unit 47. The data processing unit 47 receives the position information on the second position P2. The data processing unit 47 generates the image correction data including the received position information on the second position P2. The data processing unit 47 transmits the generated image correction data to the projector 20 via the communication interface 51. The data processing unit 47 transmits the image correction data including the position information on the second position P2 to the projector 20. Accordingly, the projection image PG is corrected.

The grid point processing is not limited to the movement processing. The lock processing corresponding to the lock operation, the selection release processing corresponding to the selection release operation, fine adjustment processing corresponding to the fine adjustment operation, and the like correspond to examples of the grid point processing. When the lock operation is received in the second cursor detection region 210b, the execution unit 45 performs the lock processing on the first grid point 147a. The lock processing is processing of disabling the input operation for the first grid point 147a. When the selection release operation is received in the second cursor detection region 210b, the execution unit 45 performs the selection release processing on the first grid point 147a. The selection release processing is processing of shifting the first grid point 147a from the grid point selected state to the grid point unselected state. When the fine adjustment operation is received in the second cursor detection region 210b, the execution unit 45 performs the fine adjustment processing on the first grid point 147a. The fine adjustment processing is processing of finely adjusting the position of the first grid point 147a.

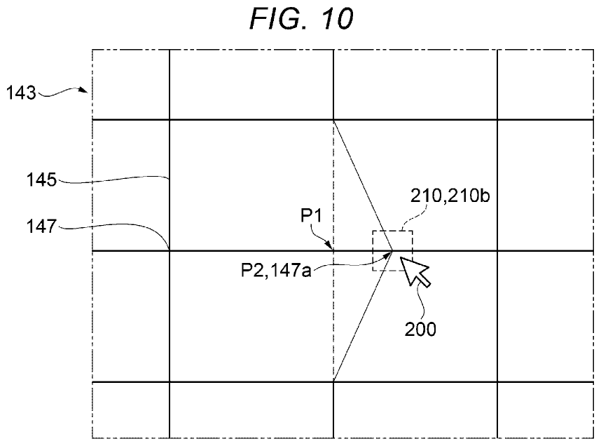

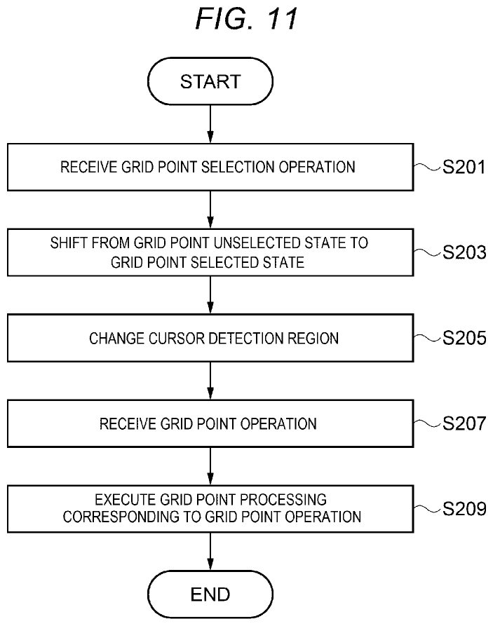

FIG. 11 illustrates a flowchart of control of the grid point 147. FIG. 11 illustrates a control procedure of the grid point 147 executed by the control unit 43. The user can control the grid point 147 by performing the input operation by using the input device 90. The control of the grid point 147 is executed by executing the image adjustment program AP by the control unit 43.

In step S201, the control unit 43 receives the grid point selection operation performed by the user. The user performs the cursor movement operation by using the input device 90. The user moves the cursor tip 200a into the first cursor detection region 210a of the first grid point 147a by performing the cursor movement operation. The first grid point 147a is in the grid point unselected state. The first cursor detection region 210a is set in advance by the execution unit 45. The user performs the grid point selection operation on the first grid point 147a. When the user performs the grid point selection operation, the input data corresponding to the grid point selection operation is transmitted from the input device 90 to the input and output unit 49. The input data includes the coordinate information on the cursor tip 200a when the grid point selection operation is performed. The input and output unit 49 receives the input data corresponding to the grid point selection operation, thereby receiving the grid point selection operation.

After the grid point selection operation is received, in step S203, the control unit 43 shifts the first grid point 147a from the grid point unselected state to the grid point selected state. The input and output unit 49 transmits the received input data corresponding to the grid point selection operation to the execution unit 45. The execution unit 45 acquires the coordinate information included in the input data corresponding to the grid point selection operation. The execution unit 45 acquires, based on the coordinate information, an operation position when the grid point selection operation is performed. The operation position is a position of the cursor tip 200a when the grid point selection operation is performed. When the execution unit 45 determines that the operation position is in the first cursor detection region 210a of the first grid point 147a, the execution unit 45 shifts the first grid point 147a from the grid point unselected state to the grid point selected state. The execution unit 45 stores information indicating that the first grid point 147a is in the grid point selected state in the memory 41.

After the first grid point 147a is shifted to the grid point selected state, in step S205, the control unit 43 changes the cursor detection region 210 of the first grid point 147a. The execution unit 45 changes the cursor detection region 210 of the first grid point 147a from the first cursor detection region 210a to the second cursor detection region 210b. The second cursor detection region 210b is different from the first cursor detection region 210a. The execution unit 45 sets the second cursor detection region 210b to be wider than the first cursor detection region 210a.

After the cursor detection region 210 is changed, in step S207, the control unit 43 receives the grid point operation. When the user performs the grid point operation on the first grid point 147a in the grid point selected state, the input and output unit 49 receives the input data corresponding to the grid point operation. The input data corresponding to the grid point operation includes the coordinate information on the cursor tip 200a when the user performs the grid point operation. The input and output unit 49 receives the input data corresponding to the grid point operation, and the grid point operation is received.

After the grid point operation is received, in step S209, the control unit 43 executes the grid point processing corresponding to the grid point operation. The input and output unit 49 transmits the received input data corresponding to the grid point operation to the execution unit 45. The execution unit 45 receives the input data corresponding to the grid point operation. The execution unit 45 determines, based on the coordinate information included in the input data, whether the grid point operation is performed in the second cursor detection region 210b of the first grid point 147a. When the execution unit 45 determines that the grid point operation is performed in the second cursor detection region 210b, the execution unit 45 executes the grid point processing corresponding to the grid point operation on the first grid point 147a. When the grid point operation is, for example, the movement operation of moving the grid point 147, the execution unit 45 executes the movement processing of moving the first grid point 147a.

The first cursor detection region 210a illustrated in FIG. 8 and the second cursor detection region 210b illustrated in FIG. 9 are illustrated in square shapes, but are not limited thereto. The first cursor detection region 210a and the second cursor detection region 210b may have circular shapes or the like. The cursor detection region 210 is set by a range of the predetermined number of pixels from the first position P1 of the first grid point 147a, a range of a predetermined distance from the first position P1 of the first grid point 147a, or the like. The first embodiment is not limited thereto as long as the first cursor detection region 210a is narrower than the second cursor detection region 210b.

### Second Embodiment

A second embodiment discloses control of the cursor detection region 210 when the grid point 147 is shifted from a grid point unselected state to a grid point selected state. The second embodiment discloses control in which the first cursor detection region 210a in the grid point unselected state is set to be wider than the second cursor detection region 210b in the grid point selected state. The first cursor detection region 210a in the grid point unselected state according to the second embodiment is the same as the first cursor detection region 210a illustrated in FIG. 8. The first cursor detection region 210a according to the second embodiment is not illustrated.

FIG. 12 illustrates a schematic configuration when a part of the preview image 143 is displayed in an enlarged manner. FIG. 12 illustrates a configuration in which any range in the preview image 143 is enlarged. FIG. 12 illustrates a plurality of grid lines 145, a plurality of grid points 147, and the cursor 200. In FIG. 12, the first inter-vertical-line distance Vd1 and the first inter-horizontal-line distance Hd1 are omitted. The first grid point 147a illustrated in FIG. 12 is in the grid point selected state. The grid points 147 other than the first grid point 147a are in the grid point unselected state.

FIG. 12 illustrates the second cursor detection region 210b of the first grid point 147a in the grid point selected state. The second cursor detection region 210b is controlled by the execution unit 45. The second cursor detection region 210b is set to include the first position P1 where the first grid point 147a is displayed. The second cursor detection region 210b is set to be narrower than the first cursor detection region 210a. The second cursor detection region 210b is the cursor detection region 210 where a grid point operation for the first grid point 147a can be received. By setting the second cursor detection region 210b to be narrower than the first cursor detection region 210a, a user is less likely to perform an erroneous grid point operation on the first grid point 147a in the grid point selected state.

When the user moves the cursor tip 200a into the first cursor detection region 210a illustrated in FIG. 8, the first grid point 147a is selectable. When the user performs a grid point selection operation with the input device 90, the first grid point 147a in the first cursor detection region 210a is selected. The selected first grid point 147a is shifted from the grid point unselected state to the grid point selected state. When the grid point selection operation is performed by the user, input data corresponding to the grid point selection operation is transmitted from the input device 90 to the input and output unit 49. The input data corresponding to the grid point selection operation includes coordinate information on the cursor tip 200a when the grid point selection operation is performed. The input and output unit 49 receives the input data corresponding to the grid point selection operation.

The input and output unit 49 transmits the received input data corresponding to the grid point selection operation to the execution unit 45. The execution unit 45 receives the input data corresponding to the grid point selection operation. The execution unit 45 acquires the coordinate information included in the input data corresponding to the grid point selection operation. The execution unit 45 determines, based on the acquired coordinate information, the grid point 147 on which the grid point selection operation is performed. When the execution unit 45 determines that the grid point 147 on which the grid point selection operation is performed is the first grid point 147a, the execution unit 45 shifts the first grid point 147a from the grid point unselected state to the grid point selected state. The execution unit 45 changes the cursor detection region 210 of the first grid point 147a from the first cursor detection region 210a to the second cursor detection region 210b illustrated in FIG. 12. The second cursor detection region 210b is different from the first cursor detection region 210a. The second cursor detection region 210b is set to be narrower than the first cursor detection region 210a.

When the user moves the cursor tip 200a to the second cursor detection region 210b of the first grid point 147a, the grid point operation for the first grid point 147a can be received. When the user performs the grid point operation by using the input device 90, the grid point operation for the first grid point 147a in the second cursor detection region 210b is executed.

When the grid point operation is performed by the user, input data corresponding to the grid point operation is transmitted from the input device 90 to the input and output unit 49. The input data corresponding to the grid point operation includes coordinate information on the cursor tip 200a when the grid point operation is performed. The input and output unit 49 receives the input data corresponding to the grid point operation.

The input and output unit 49 transmits the received input data corresponding to the grid point operation to the execution unit 45. The execution unit 45 receives the input data corresponding to the grid point operation. The execution unit 45 acquires the coordinate information included in the input data corresponding to the grid point operation. The execution unit 45 determines, based on the acquired coordinate information, the grid point 147 on which the grid point operation is performed. When the execution unit 45 determines that the grid point 147 on which the grid point operation is performed is the first grid point 147a, the execution unit 45 executes grid point processing corresponding to the grid point operation for the first grid point 147a.

A control method of controlling the grid point 147 according to the second embodiment is the same as the flowchart illustrated in FIG. 11. In the second embodiment, in step S205 illustrated in FIG. 11, the control unit 43 sets the second cursor detection region 210b to be narrower than the first cursor detection region 210a.

The control method includes shifting, when the grid point selection operation for the first grid point 147a displayed on the display 80 is received in the first cursor detection region 210a including the first position P1 of the first grid point 147a, the first grid point 147a from the grid point unselected state to the grid point selected state, and executing, when the grid point operation for the first grid point 147a in the grid point selected state is received in the second cursor detection region 210b including the first position P1 and different from the first cursor detection region 210a, the grid point processing corresponding to the grid point operation on the first grid point 147a in the grid point selected state.

Since the first cursor detection region 210a is different from the second cursor detection region 210b, operability of the user is improved. When the first cursor detection region 210a is wider than the second cursor detection region 210b, a possibility of occurrence of an erroneous operation on the first grid point 147a in the grid point selected state is reduced. When the second cursor detection region 210b is wider than the first cursor detection region 210a, the user can easily operate the first grid point 147a in the grid point selected state.

The grid point operation may be a movement operation, and the grid point processing may be movement processing of moving the first grid point 147a from the first position P1 to the second position P2 designated based on the movement operation.

The user can move the first grid point 147a in the grid point selected state.

When the movement processing is executed on the first grid point 147a, image correction data including position information on the second position P2 is generated and output.

Position information on the first grid point 147a moved to the second position P2 by the movement processing can be output to the projector 20. The projector 20 can perform various types of processing based on the output position information.

The display control device 40 includes the control unit 43 and the input and output unit 49. The control unit 43 shifts, when the grid point selection operation for the first grid point 147a displayed on the display 80 in the grid point unselected state is received in the first cursor detection region 210a including the first position P1 of the first grid point 147a, the first grid point 147a from the grid point unselected state to the grid point selected state, and executes, when the grid point operation for the first grid point 147a in the grid point selected state is received in the second cursor detection region 210b including the first position P1 and different from the first cursor detection region 210a, the grid point processing corresponding to the grid point operation on the first grid point 147a in the grid point selected state. The input and output unit 49 receives the grid point selection operation and the grid point operation.

Since the first cursor detection region 210a is different from the second cursor detection region 210b, the display control device 40 can improve the operability of the user.

The image adjustment program AP causes, when the grid point selection operation for the first grid point 147a displayed on the display 80 is received in the first cursor detection region 210a including the first position P1 of the first grid point 147a, the first grid point 147a to be shifted from the grid point unselected state to the grid point selected state, and causes, when the grid point operation for the first grid point 147a in the grid point selected state is received in the second cursor detection region 210b including the first position P1 and different from the first cursor detection region 210a, the grid point processing corresponding to the grid point operation to be executed on the first grid point 147a in the grid point selected state.

Since the first cursor detection region 210a is different from the second cursor detection region 210b, the image adjustment program AP can provide the display control device 40 with high operability.

### Third Embodiment

A third embodiment discloses control of the cursor detection region 210 when the grid line 145 is shifted from a grid line unselected state to a grid line selected state. The grid line unselected state corresponds to an example of an unselected state. The grid line selected state corresponds to an example of a selected state. The third embodiment discloses control in which a third cursor detection region 210c in the grid line unselected state is set to be narrower than a fourth cursor detection region 210d in the grid line selected state. The third cursor detection region 210c and the fourth cursor detection region 210d are examples of the cursor detection region 210. The third cursor detection region 210c corresponds to an example of a first detection region. The fourth cursor detection region 210d corresponds to an example of a second detection region.

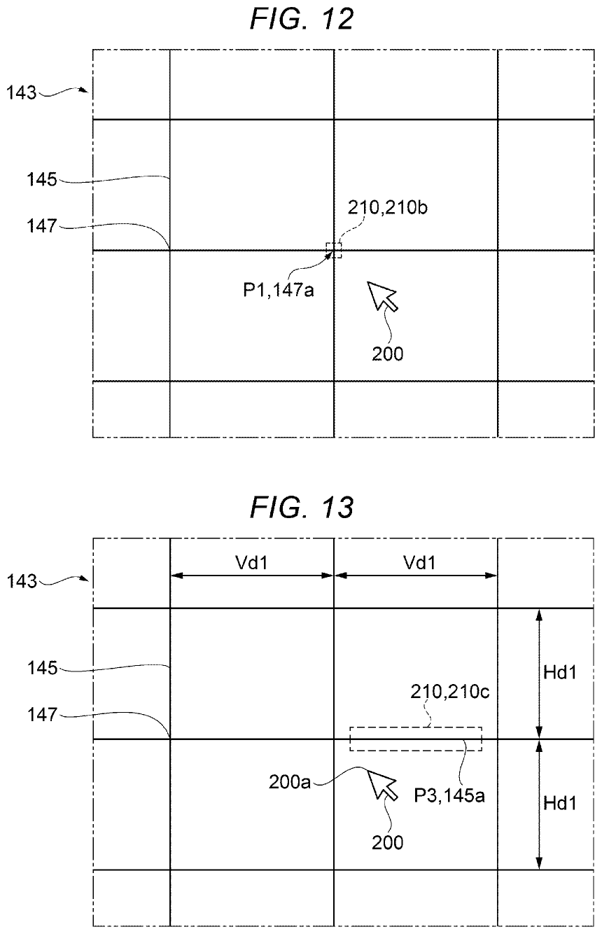

FIG. 13 illustrates a schematic configuration when a part of the preview image 143 is displayed in an enlarged manner. FIG. 13 illustrates a configuration in which any range in the preview image 143 is enlarged. FIG. 13 illustrates a plurality of grid lines 145, a plurality of grid points 147, and the cursor 200. The grid lines 145 extending along a vertical axis are arranged at the first inter-vertical-line distance Vd1. The grid lines 145 extending along a horizontal axis are arranged at the first inter-horizontal-line distance Hd1. The grid line 145 illustrated in FIG. 13 is in the grid line unselected state, which means the grid line 145 is not selected by an input operation of a user.

FIG. 13 illustrates the third cursor detection region 210c of a first grid line 145a that is a part of the plurality of grid lines 145. The first grid line 145a is the grid line 145 between two grid points 147. The first grid line 145a illustrated in FIG. 13 is in the grid line unselected state. The third cursor detection region 210c is controlled by the execution unit 45. The third cursor detection region 210c is set to include a third position P3 where the first grid line 145a is displayed. The third position P3 corresponds to an example of a display position.

When the user moves the cursor tip 200a into the third cursor detection region 210c, the first grid line 145a is selectable. The third cursor detection region 210c is a region where a grid line selection operation for the first grid line 145a can be received. When the user performs the grid line selection operation with the input device 90, the first grid line 145a in the third cursor detection region 210c is selected. The selected first grid line 145a is shifted from the grid line unselected state to the grid line selected state. The grid line selection operation is, for example, a click operation using the mouse 90b. The grid line selection operation is set in advance. When the grid line selection operation is performed by the user, input data corresponding to the grid line selection operation is transmitted from the input device 90 to the input and output unit 49. The input data corresponding to the grid line selection operation includes coordinate information on the cursor tip 200a when the grid line selection operation is performed. The input and output unit 49 receives the input data corresponding to the grid line selection operation. The grid line selection operation corresponds to an example of a selection operation.

The input and output unit 49 transmits the received input data corresponding to the grid line selection operation to the execution unit 45. The execution unit 45 receives the input data corresponding to the grid line selection operation. The execution unit 45 acquires the coordinate information included in the input data corresponding to the grid line selection operation. The execution unit 45 determines, based on the acquired coordinate information, the grid line 145 on which the grid line selection operation is performed. When the execution unit 45 determines that the grid line 145 on which the grid line selection operation is performed is the first grid line 145a, the execution unit 45 shifts the first grid line 145a from the grid line unselected state to the grid line selected state. The execution unit 45 changes the cursor detection region 210 of the first grid line 145a from the third cursor detection region 210c to the fourth cursor detection region 210d. The fourth cursor detection region 210d is different from the third cursor detection region 210c.

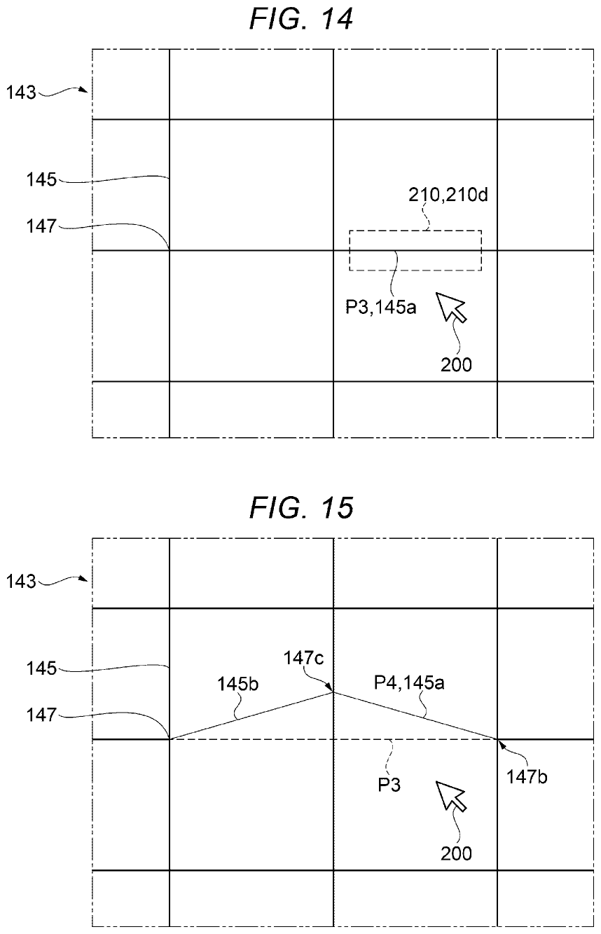

FIG. 14 illustrates a schematic configuration when a part of the preview image 143 is displayed in an enlarged manner. FIG. 14 illustrates a configuration in which any range in the preview image 143 is enlarged. FIG. 14 illustrates the plurality of grid lines 145, the plurality of grid points 147, and the cursor 200. In FIG. 14, the first inter-vertical-line distance Vd1 and the first inter-horizontal-line distance Hd1 are omitted. The first grid line 145a illustrated in FIG. 14 is in the grid line selected state. The grid lines 145 other than the first grid line 145a are in the grid line unselected state.

FIG. 14 illustrates the fourth cursor detection region 210d of the first grid line 145a in the grid line selected state. The fourth cursor detection region 210d is controlled by the execution unit 45. The fourth cursor detection region 210d is set to include the third position P3 where the first grid line 145a is displayed. The fourth cursor detection region 210d is set to be wider than the third cursor detection region 210c. The fourth cursor detection region 210d is the cursor detection region 210 where a grid line operation for the first grid line 145a can be received. By setting the fourth cursor detection region 210d to be wider than the third cursor detection region 210c, the user can easily perform an input operation on the first grid line 145a in the grid line selected state.

When the user moves the cursor tip 200a to the fourth cursor detection region 210d of the first grid line 145a, the grid line operation for the first grid line 145a can be received. When the user performs the grid line operation by using the input device 90, the grid line operation for the first grid line 145a in the fourth cursor detection region 210d is executed.

The grid line operation is, for example, a drag operation using the mouse 90b. The grid line operation may be a double-click operation using the mouse 90b. The grid line operation may be a click operation using the mouse 90b. The grid line operation may be a control drag operation on the mouse 90b in a state where the user presses a predetermined key in the keyboard 90a. The grid line operation is set in advance. The drag operation corresponds to, for example, a rotational movement operation for the first grid line 145a. The rotational movement operation is an operation of rotationally moving the grid line 145 around the grid point 147. The double-click operation corresponds to a lock operation for the first grid line 145a. The lock operation is an operation of disabling the input operation for the first grid line 145a. The click operation corresponds to a selection release operation. The selection release operation is an operation of shifting the first grid line 145a from the grid line selected state to the grid line unselected state. The control drag operation is a parallel movement operation. The parallel movement operation is an operation of parallelly moving the first grid line 145a. The grid line 145 extending along the vertical axis is parallelly moved along the horizontal axis. The grid line 145 extending along the horizontal axis is parallelly moved along the vertical axis. A correlation between the grid line operation and the input operation is appropriately set. The grid line operation corresponds to an example of an image operation.

When the grid line operation is performed by the user, input data corresponding to the grid line operation is transmitted from the input device 90 to the input and output unit 49. The input data corresponding to the grid line operation includes coordinate information on the cursor tip 200a when the grid line operation is performed. The input and output unit 49 receives the input data corresponding to the grid line operation.

The input and output unit 49 transmits the received input data corresponding to the grid line operation to the execution unit 45. The execution unit 45 receives the input data corresponding to the grid line operation. The execution unit 45 acquires the coordinate information included in the input data corresponding to the grid line operation. The execution unit 45 determines, based on the acquired coordinate information, the grid line 145 on which the grid line operation is performed. When the execution unit 45 determines that the grid line 145 on which the grid line operation is performed is the first grid line 145a, the execution unit 45 executes grid line processing on the first grid line 145a. The grid line processing corresponds to the grid line operation.

FIG. 15 illustrates a schematic configuration when a part of the preview image 143 is displayed in an enlarged manner. FIG. 15 illustrates a configuration in which any range in the preview image 143 is enlarged. FIG. 15 illustrates the plurality of grid lines 145, the plurality of grid points 147, and the cursor 200. In FIG. 15, the first inter-vertical-line distance Vd1 and the first inter-horizontal-line distance Hd1 are omitted. The first grid line 145a illustrated in FIG. 15 is in a state where the grid line processing corresponding to the grid line operation is executed.

The first grid line 145a illustrated in FIG. 15 is rotationally moved to a fourth position P4 different from the third position P3 which is a position of the first grid line 145a illustrated in FIG. 14. FIG. 15 illustrates a state where rotational movement processing corresponding to the rotational movement operation is executed on the first grid line 145a. The rotational movement processing is an example of the grid line processing. By the rotational movement processing, the first grid line 145a is rotationally moved around a second grid point 147b. A third grid point 147c which is one end of the first grid line 145a is moved. The first grid line 145a is moved from the third position P3 to the fourth position P4. The grid line processing corresponds to an example of processing corresponding to the image operation. When the drag operation is performed while the cursor tip 200a is located in the fourth cursor detection region 210d, the first grid line 145a is rotationally moved from the third position P3 to the fourth position P4 in response to the drag operation. When the rotational movement operation is received in the fourth cursor detection region 210d, the rotational movement processing of rotationally moving the first grid line 145a is executed. The third position P3 corresponds to the example of the display position. The fourth position P4 corresponds to an example of a movement position.

The third grid point 147c illustrated in FIG. 15 is moved along the vertical axis when the first grid line 145a is rotationally moved. When the first grid line 145a is rotationally moved from the third position P3 to the fourth position P4, a length of the first grid line 145a at the fourth position P4 is larger than that of the first grid line 145a at the third position P3. A movement direction of the third grid point 147c is not limited to a movement direction illustrated in FIG. 15. When the first grid line 145a is rotationally moved around the second grid point 147b, the third grid point 147c may be moved along a circular trajectory. When the third grid point 147c is moved along the circular trajectory, a length of the first grid line 145a does not change.

When the third grid point 147c is moved, a second grid line 145b using the third grid point 147c as one end thereof is rotationally moved. When the first grid line 145a is rotationally moved, the second grid line 145b coupled to the first grid line 145a is rotationally moved.

The first grid line 145a illustrated in FIG. 15 is rotationally moved around the second grid point 147b, but is not limited thereto. The first grid line 145a may be rotationally moved around the third grid point 147c. A rotation center when the first grid line 145a is rotationally moved is set in advance by the execution unit 45. The execution unit 45 may control the rotation center of the first grid line 145a based on coordinate information included in input data corresponding to the rotational movement operation.

When the first grid line 145a is rotationally moved from the third position P3 to the fourth position P4, the execution unit 45 transmits position information on the fourth position P4 to the data processing unit 47. The data processing unit 47 receives the position information on the fourth position P4. The data processing unit 47 generates image correction data including the received position information on the fourth position P4. The data processing unit 47 transmits the generated image correction data to the projector 20 via the communication interface 51. The data processing unit 47 transmits the image correction data including the position information on the fourth position P4 to the projector 20. Accordingly, the projection image PG is corrected.

The grid line processing is not limited to the rotational movement processing. Lock processing corresponding to the lock operation, selection release processing corresponding to the selection release operation, parallel movement processing corresponding to the parallel movement operation, and the like correspond to examples of the grid line processing. When the lock operation is received in the fourth cursor detection region 210d, the execution unit 45 performs the lock processing on the first grid line 145a. The lock processing is processing of disabling the input operation for the first grid line 145a. When the selection release operation is received in the fourth cursor detection region 210d, the execution unit 45 performs the selection release processing on the first grid line 145a. The selection release processing is processing of shifting the first grid line 145a from the grid line selected state to the grid line unselected state. When the parallel movement operation is received in the fourth cursor detection region 210d, the execution unit 45 performs the parallel movement processing on the first grid line 145a. The parallel movement processing is processing of parallelly moving the first grid line 145a.

A control method of controlling the grid line 145 according to the third embodiment is the same as the flowchart illustrated in FIG. 11. In the third embodiment, in step S205 illustrated in FIG. 11, the control unit 43 sets the fourth cursor detection region 210d to be wider than the third cursor detection region 210c.

The control method includes shifting, when the grid line selection operation for the first grid line 145a displayed on display 80 is received in the third cursor detection region 210c including the third position P3 of the first grid line 145a, the first grid line 145a from the grid line unselected state to the grid line selected state, and executing, when the grid line operation for the first grid line 145a in the grid line selected state is received in the fourth cursor detection region 210d including the third position P3 and different from the third cursor detection region 210c, the grid line processing corresponding to the grid line operation on the first grid line 145a in the grid line selected state.

Since the third cursor detection region 210c is different from the fourth cursor detection region 210d, operability of the user is improved. When the third cursor detection region 210c is wider than the fourth cursor detection region 210d, a possibility of occurrence of an erroneous operation on the first grid line 145a in the grid line selected state is reduced. When the fourth cursor detection region 210d is wider than the third cursor detection region 210c, the user can easily operate the first grid line 145a in the grid line selected state.

### Fourth Embodiment

A fourth embodiment discloses control of the cursor detection region 210 when the grid line 145 is shifted from a grid line unselected state to a grid line selected state. The fourth embodiment discloses control in which a fifth cursor detection region 210e in the grid line unselected state is set to be wider than a sixth cursor detection region 210f in the grid line selected state. The fifth cursor detection region 210e and the sixth cursor detection region 210f are examples of the cursor detection region 210. The fifth cursor detection region 210e corresponds to an example of a first detection region. The sixth cursor detection region 210f corresponds to an example of a second detection region.

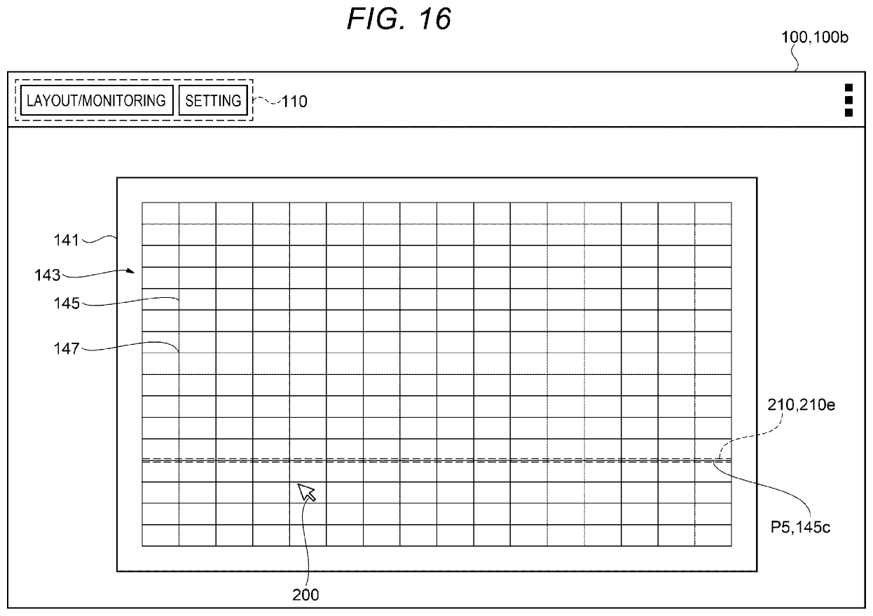

FIG. 16 illustrates a configuration of the management screen 100. FIG. 16 illustrates the second management screen 100b which is an example of the management screen 100. The second management screen 100b illustrated in FIG. 16 has the same configuration as that of the second management screen 100b illustrated in FIG. 7 except for the fifth cursor detection region 210e illustrated on the preview image 143. The second management screen 100b is displayed on the display 80 under control of the display control device 40. The second management screen 100b is displayed on the display 80 when the display control device 40 executes the image adjustment program AP. The second management screen 100b is a screen displayed when geometric distortion correction is performed.

FIG. 16 illustrates the fifth cursor detection region 210e of a third grid line 145c that is one of a plurality of grid lines 145. In FIG. 16, all of the grid lines 145 extending along a horizontal axis are illustrated as the third grid line 145c. The third grid line 145c illustrated in FIG. 16 is in the grid line unselected state. The fifth cursor detection region 210e is controlled by the execution unit 45. The fifth cursor detection region 210e is set to include a fifth position P5 where the third grid line 145c is displayed. The fifth cursor detection region 210e is a region wider than a line width of the third grid line 145c. The fifth position P5 corresponds to an example of a display position.

When a user moves the cursor tip 200a into the fifth cursor detection region 210e, the third grid line 145c is selectable. The fifth cursor detection region 210e is a region where a grid line selection operation for the third grid line 145c can be received. When the user performs the grid line selection operation with the input device 90, the third grid line 145c in the fifth cursor detection region 210e is selected. The selected third grid line 145c is shifted from the grid line unselected state to the grid line selected state. The grid line selection operation is, for example, a click operation using the mouse 90b. The grid line selection operation is set in advance. When the grid line selection operation is performed by the user, input data corresponding to the grid line selection operation is transmitted from the input device 90 to the input and output unit 49. The input data corresponding to the grid line selection operation includes coordinate information on the cursor tip 200a when the grid line selection operation is performed. The input and output unit 49 receives the input data corresponding to the grid line selection operation.

The input and output unit 49 transmits the received input data corresponding to the grid line selection operation to the execution unit 45. The execution unit 45 receives the input data corresponding to the grid line selection operation. The execution unit 45 acquires the coordinate information included in the input data corresponding to the grid line selection operation. The execution unit 45 determines, based on the acquired coordinate information, the grid line 145 on which the grid line selection operation is performed. When the execution unit 45 determines that the grid line 145 on which the grid line selection operation is performed is the third grid line 145c, the execution unit 45 shifts the third grid line 145c from the grid line unselected state to the grid line selected state. The execution unit 45 changes the cursor detection region 210 of the third grid line 145c from the fifth cursor detection region 210e to the sixth cursor detection region 210f. The fifth cursor detection region 210e is different from the sixth cursor detection region 210f.

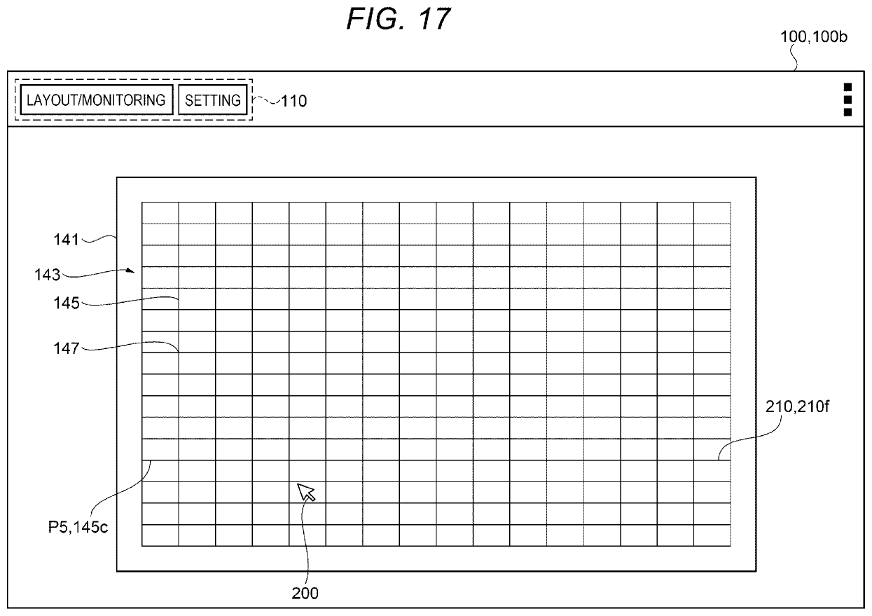

FIG. 17 illustrates a configuration of the management screen 100. FIG. 17 illustrates the second management screen 100b which is an example of the management screen 100. FIG. 17 illustrates the sixth cursor detection region 210f. The sixth cursor detection region 210f is a region having the same line width as that of the third grid line 145c. The sixth cursor detection region 210f is set to include the fifth position P5 where the third grid line 145c is displayed. The third grid line 145c illustrated in FIG. 17 is in the grid line selected state. The grid lines 145 other than the third grid line 145c are in the grid line unselected state.

The sixth cursor detection region 210f is controlled by the execution unit 45. The sixth cursor detection region 210f is set to be narrower than the fifth cursor detection region 210e. The sixth cursor detection region 210f is a region where a grid line operation for the third grid line 145c can be received. By setting the sixth cursor detection region 210f to be narrower than the fifth cursor detection region 210e, the user is less likely to erroneously operate the third grid line 145c in the grid line selected state.

When the user moves the cursor tip 200a to the sixth cursor detection region 210f of the third grid line 145c, the grid line operation for the third grid line 145c can be received. When the user performs the grid line operation by using the input device 90, the grid line operation for the third grid line 145c in the sixth cursor detection region 210f is executed.

The grid line operation is, for example, a control drag operation using the keyboard 90a and the mouse 90b. The control drag operation corresponds to, for example, a parallel movement operation for the third grid line 145c. The parallel movement operation is an operation of parallelly moving the grid line 145. The grid line 145 extending along a vertical axis is parallelly moved along the horizontal axis by the parallel movement operation. The grid line 145 extending along the horizontal axis is parallelly moved along the vertical axis by the parallel movement operation.

When the grid line operation is performed by the user, input data corresponding to the grid line operation is transmitted from the input device 90 to the input and output unit 49. The input data corresponding to the grid line operation includes coordinate information on the cursor tip 200a when the grid line operation is performed. The input and output unit 49 receives the input data corresponding to the grid line operation.

The input and output unit 49 transmits the received input data corresponding to the grid line operation to the execution unit 45. The execution unit 45 receives the input data corresponding to the grid line operation. The execution unit 45 acquires the coordinate information included in the input data corresponding to the grid line operation. The execution unit 45 determines, based on the acquired coordinate information, the grid line 145 on which the parallel movement operation which is the grid line operation is performed. When the execution unit 45 determines that the grid line 145 on which the parallel movement operation is performed is the third grid line 145c, the execution unit 45 executes the parallel movement processing on the third grid line 145c.

A control method of controlling the grid line 145 according to the fourth embodiment is the same as the flowchart illustrated in FIG. 11. In the fourth embodiment, in step S205 illustrated in FIG. 11, the control unit 43 sets the sixth cursor detection region 210f to be narrower than the fifth cursor detection region 210e.

### Fifth Embodiment

A fifth embodiment discloses control of the cursor detection region 210 when the grid point 147 is shifted from a grid point unselected state to a grid point selected state. The fifth embodiment discloses control in which a seventh cursor detection region 210g in the grid point unselected state is set to be narrower than an eighth cursor detection region 210h in the grid point selected state. The seventh cursor detection region 210g and the eighth cursor detection region 210h are examples of the cursor detection region 210. The seventh cursor detection region 210g corresponds to an example of a first detection region. The eighth cursor detection region 210h corresponds to an example of a second detection region.

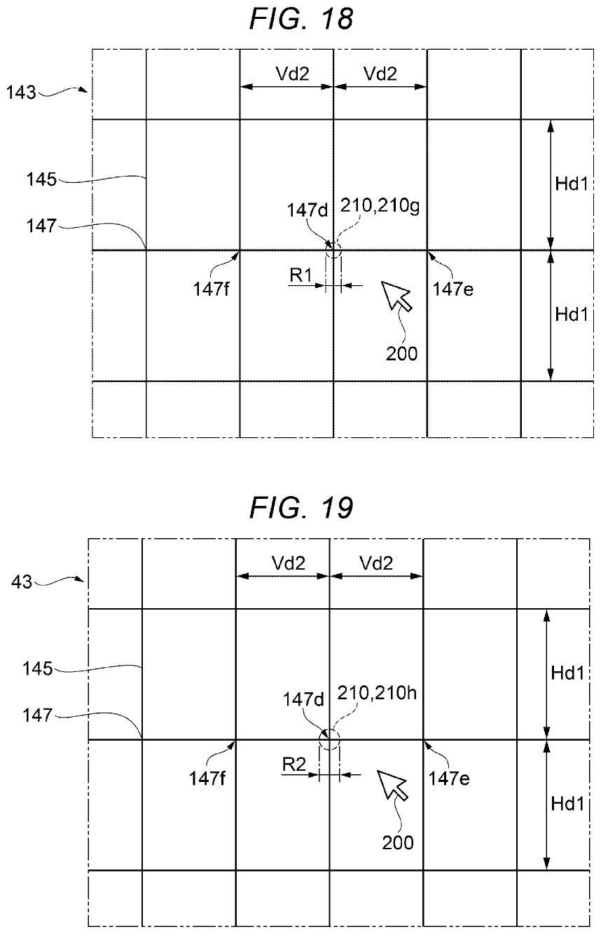

FIG. 18 illustrates a schematic configuration when a part of the preview image 143 is displayed in an enlarged manner. FIG. 18 illustrates a configuration in which any range in the preview image 143 is enlarged. FIG. 18 illustrates a plurality of grid lines 145, a plurality of grid points 147, and the cursor 200. The grid lines 145 extending along a vertical axis are arranged at a second inter-vertical-line distance Vd2. The second inter-vertical-line distance Vd2 is narrower than the first inter-vertical-line distance Vd1 illustrated in FIG. 8. The grid lines 145 extending along a horizontal axis are arranged at the first inter-horizontal-line distance Hd1. A distance between the adjacent grid lines 145 and a distance between the adjacent grid points 147 are set, for example, by the correction setter 131. The distance between the adjacent grid lines 145 and the distance between the adjacent grid points 147 are adjusted when the user corrects the preview image 143. The grid points 147 including a fourth grid point 147d illustrated in FIG. 18 are in the grid point unselected state, which means the grid points 147 are not selected by an input operation of the user.

FIG. 18 illustrates the seventh cursor detection region 210g of the fourth grid point 147d which is one of the plurality of grid points 147. The seventh cursor detection region 210g illustrated in FIG. 18 is a circular region having a first region diameter R1. A center of the seventh cursor detection region 210g is the fourth grid point 147d. The seventh cursor detection region 210g is controlled by the execution unit 45. The seventh cursor detection region 210g is set based on a distance between the fourth grid point 147d and the adjacent grid point 147. The execution unit 45 can adjust a distance between the seventh cursor detection region 210g and the cursor detection region 210 of the adjacent grid point 147 by setting the seventh cursor detection region 210g based on the distance between the fourth grid point 147d and the adjacent grid point 147.

The seventh cursor detection region 210g is set by a distance between the fourth grid point 147d and a fifth grid point 147e. The seventh cursor detection region 210g may be set by a distance between the fourth grid point 147d and a sixth grid point 147f. The fifth grid point 147e and the sixth grid point 147f are the grid points 147 adjacent to the fourth grid point 147d along the horizontal axis. The seventh cursor detection region 210g may be set by the distance between the fourth grid point 147d and the fifth grid point 147e and the distance between the fourth grid point 147d and the sixth grid point 147f. The fifth grid point 147e or the sixth grid point 147f corresponds to an example of a display image.

As illustrated in FIG. 18, when the distance between the fourth grid point 147d and the sixth grid point 147f is the second inter-vertical-line distance Vd2, the seventh cursor detection region 210g is set to be the circular region having the first region diameter R1. When the distance between the fourth grid point 147d and the sixth grid point 147f is the first inter-vertical-line distance Vd1 which is larger than the second inter-vertical-line distance Vd2, for example, the seventh cursor detection region 210g is set to be a circular region having a region diameter larger than the first region diameter R1. When the region diameter increases, the cursor detection region 210 increases.

The execution unit 45 may set the seventh cursor detection region 210g based on a predetermined setting value. When the second inter-vertical-line distance Vd2, which is the distance between the fourth grid point 147d and the fifth grid point 147e, is smaller than the predetermined setting value, the seventh cursor detection region 210g is set to be the circular region having the first region diameter R1. When the second inter-vertical-line distance Vd2 is larger than the predetermined setting value, the seventh cursor detection region 210g is set to be a circular region having a region diameter larger than the first region diameter R1. The execution unit 45 sets the seventh cursor detection region 210g by a distance between the adjacent grid points 147. The execution unit 45 adjusts a detection region of the seventh cursor detection region 210g, the distance from the adjacent grid point 147, and a shape of the seventh cursor detection region 210g. The execution unit 45 sets the seventh cursor detection region 210g by adjusting the detection region or the like of the seventh cursor detection region 210g.

The seventh cursor detection region 210g may be set by a distance between the grid points adjacent to each other along the vertical axis. The seventh cursor detection region 210g may be set by a distance between the grid points 147 adjacent to each other along the vertical axis and a distance between the grid points 147 adjacent to each other along the horizontal axis. When the cursor detection region 210 has a quadrangular shape, the execution unit 45 may set the cursor detection region 210 by adjusting a length of a side of the quadrangular shape.

When the user moves the cursor tip 200a into the seventh cursor detection region 210g, the fourth grid point 147d can be selected. When the user performs a grid point selection operation with the input device 90, the fourth grid point 147d in the seventh cursor detection region 210g is selected. The selected fourth grid point 147d is shifted from the grid point unselected state to the grid point selected state. The grid point selection operation is, for example, a click operation using the mouse 90b. The grid point selection operation is set in advance. When the grid point selection operation is performed by the user, input data corresponding to the grid point selection operation is transmitted from the input device 90 to the input and output unit 49. The input data corresponding to the grid point selection operation includes coordinate information on the cursor tip 200a when the grid point selection operation is performed. The input and output unit 49 receives the input data corresponding to the grid point selection operation.

The input and output unit 49 transmits the received input data corresponding to the grid point selection operation to the execution unit 45. The execution unit 45 receives the input data corresponding to the grid point selection operation. The execution unit 45 acquires the coordinate information included in the input data corresponding to the grid point selection operation. The execution unit 45 determines, based on the acquired coordinate information, the grid point 147 on which the grid point selection operation is performed. When the execution unit 45 determines that the grid point 147 on which the grid point selection operation is performed is the fourth grid point 147d, the execution unit 45 shifts the fourth grid point 147d from the grid point unselected state to the grid point selected state. The execution unit 45 changes the cursor detection region 210 of the fourth grid point 147d from the seventh cursor detection region 210g to the eighth cursor detection region 210h. The eighth cursor detection region 210h is different from the seventh cursor detection region 210g.

FIG. 19 illustrates a schematic configuration when a part of the preview image 143 is displayed in an enlarged manner. FIG. 19 illustrates a configuration in which any range in the preview image 143 is enlarged. FIG. 19 illustrates the plurality of grid lines 145, the plurality of grid points 147, and the cursor 200. The fourth grid point 147d illustrated in FIG. 19 is in the grid point selected state. The grid points 147 other than the fourth grid point 147d are in the grid point unselected state.

FIG. 19 illustrates the eighth cursor detection region 210h of the fourth grid point 147d in the grid point selected state. The eighth cursor detection region 210h is controlled by the execution unit 45. The eighth cursor detection region 210h is set to be wider than the seventh cursor detection region 210g. The eighth cursor detection region 210h is a region where a grid point operation for the fourth grid point 147d can be received. By setting the eighth cursor detection region 210h to be wider than the seventh cursor detection region 210g, the user can easily perform an input operation on the fourth grid point 147d in the grid point selected state.

Similarly to the seventh cursor detection region 210g, the eighth cursor detection region 210h is set by the distance between the fourth grid point 147d and the fifth grid point 147e. The eighth cursor detection region 210h may be set by the distance between the fourth grid point 147d and the sixth grid point 147f. The eighth cursor detection region 210h may be set by the distance between the fourth grid point 147d and the fifth grid point 147e and the distance between the fourth grid point 147d and the sixth grid point 147f.

As illustrated in FIG. 19, when the distance between the fourth grid point 147d and the sixth grid point 147f is the second inter-vertical-line distance Vd2, the eighth cursor detection region 210h is set to be a circular region having a second region diameter R2. The second region diameter R2 is larger than the first region diameter R1. When the distance between the fourth grid point 147d and the sixth grid point 147f is the first inter-vertical-line distance Vd1 larger than the second inter-vertical-line distance Vd2, for example, the eighth cursor detection region 210h is set to be a circular region having a region diameter larger than the second region diameter R2. When the region diameter increases, the cursor detection region 210 increases. The execution unit 45 sets the eighth cursor detection region 210h by a distance between the adjacent grid points 147. The execution unit 45 adjusts a detection region of the eighth cursor detection region 210h, the distance from the adjacent grid point 147, and a shape of the eighth cursor detection region 210h. The execution unit 45 sets the eighth cursor detection region 210h by adjusting the detection region or the like of the eighth cursor detection region 210h. The execution unit 45 can adjust a distance between the eighth cursor detection region 210h and the cursor detection region 210 of the adjacent grid point 147 by setting the eighth cursor detection region 210h based on the distance between the fourth grid point 147d and the adjacent grid point 147.

When the user moves the cursor tip 200a to the eighth cursor detection region 210h of the fourth grid point 147d, the grid point operation for the fourth grid point 147d can be received. When the user performs the grid point operation by using the input device 90, the grid point operation for the fourth grid point 147d in the eighth cursor detection region 210h is executed.

When the grid point operation is performed by the user, input data corresponding to the grid point operation is transmitted from the input device 90 to the input and output unit 49. The input data corresponding to the grid point operation includes coordinate information on the cursor tip 200a when the grid point operation is performed. The input and output unit 49 receives the input data corresponding to the grid point operation.

The input and output unit 49 transmits the received input data corresponding to the grid point operation to the execution unit 45. The execution unit 45 receives the input data corresponding to the grid point operation. The execution unit 45 acquires the coordinate information included in the input data corresponding to the grid point operation. The execution unit 45 determines, based on the acquired coordinate information, the grid point 147 on which the grid point operation is performed. When the execution unit 45 determines that the grid point 147 on which the grid point operation is performed is the fourth grid point 147d, the execution unit 45 executes grid point processing on the fourth grid point 147d. The grid point processing corresponds to the grid point operation.

When the fifth grid point 147e adjacent to the fourth grid point 147d is displayed on the display 80, the seventh cursor detection region 210g and the eighth cursor detection region 210h are set by the distance between the fourth grid point 147d and the fifth grid point 147e.

By setting the seventh cursor detection region 210g based on the distance between the adjacent grid points 147, the distance between the seventh cursor detection region 210g and the cursor detection region 210 of the adjacent grid point 147 can be adjusted. By setting the eighth cursor detection region 210h by the distance between the adjacent grid points 147, the distance between the eighth cursor detection region 210h and the cursor detection region 210 of the adjacent grid point 147 can be adjusted.

The fifth embodiment discloses a case where the cursor detection region 210 is set by the distance between the adjacent grid points 147, but is not limited thereto. The display control device 40 may set the cursor detection region 210 by a distance between the adjacent grid lines 145.

### Sixth Embodiment

The sixth embodiment discloses that the cursor detection region 210 is set by performing an input operation on the management screen 100 by a user. The cursor detection region 210 in a grid point selected state is set by the input operation for the management screen 100. The cursor detection region 210 in a grid line selected state may be set by the input operation for the management screen 100. The cursor detection region 210 in the grid point selected state or the cursor detection region 210 in the grid line selected state is switched according to a setting mode.

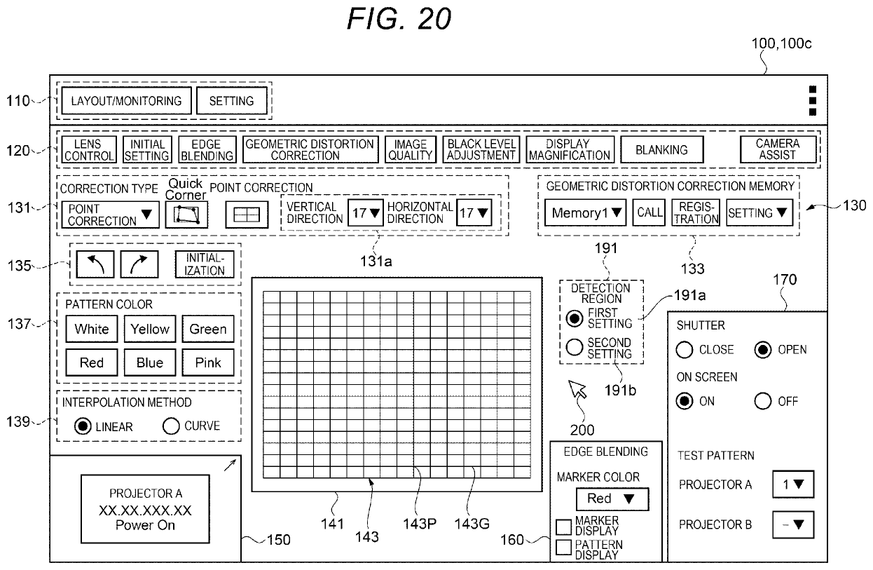

FIG. 20 illustrates a configuration of the management screen 100. The management screen 100 is displayed on the display 80 under control of the display control device 40. The management screen 100 is displayed on the display 80 when the display control device 40 executes the image adjustment program AP. The management screen 100 illustrated in FIG. 20 is a screen displayed when geometric distortion correction is performed. FIG. 20 illustrates a third management screen 100c which is an example of the management screen 100.

In the third management screen 100c, a detection region setter 191 is displayed. The third management screen 100c has the same configuration as the first management screen 100a illustrated in FIG. 6 except for the detection region setter 191. The third management screen 100c is displayed on the display 80 instead of the first management screen 100a. The third management screen 100c may be switched from the first management screen 100a and displayed on the display 80 when the user performs a predetermined input operation.

The detection region setter 191 is used to switch the setting mode of the cursor detection region 210. The detection region setter 191 receives the input operation performed by the user. The user performs the input operation by using the input device 90. When receiving the input operation performed by the user, the detection region setter 191 displays the setting mode selected by the input operation. When the user performs the input operation on the detection region setter 191, the input device 90 transmits input data related to the setting mode to the input and output unit 49. The input and output unit 49 receives the input data related to the setting mode. The input and output unit 49 transmits the input data related to the setting mode to the execution unit 45. The execution unit 45 receives the input data related to the setting mode. The execution unit 45 controls the cursor detection region 210 based on the received input data related to the setting mode.

The detection region setter 191 includes a first setting field 191a and a second setting field 191b. The user performs the input operation on the first setting field 191a or the second setting field 191b in the detection region setter 191. When selecting a first setting, the user performs the input operation on the first setting field 191a. When selecting a second setting, the user performs the input operation on the second setting field 191b. When the user does not perform the input operation on the detection region setter 191, the detection region setter 191 displays the first setting field 191a or the second setting field 191b in a selected state as a standard setting. The user performs a setting switching operation of switching between the first setting and the second setting by performing the input operation on the first setting field 191a or the second setting field 191b. The setting switching operation corresponds to an example of a switching operation. The first setting corresponds to an example of a first mode. The second setting corresponds to an example of a second mode.

The first setting field 191a receives the input operation performed by the user. When the user performs the input operation on the first setting field 191a, the first setting field 191a performs display indicating that the first setting field 191a is selected by the user. FIG. 20 illustrates that the first setting field 191a is selected. When the input operation is performed on the first setting field 191a, the input data related to the setting mode is transmitted from the input device 90 to the input and output unit 49. The input data related to the setting mode is first setting data indicating that the first setting is selected. The first setting relates to a setting of the cursor detection region 210. The first setting is, for example, a setting in which the cursor detection region 210 in a grid point unselected state is wider than the cursor detection region 210 in a grid point selected state.

The input and output unit 49 receives the first setting data. The input and output unit 49 transmits the received first setting data to the execution unit 45. The execution unit 45 receives the first setting data. The execution unit 45 sets the cursor detection region 210 based on the first setting data. For example, the execution unit 45 sets the cursor detection region 210 of the grid point 147 in the grid point unselected state as the first cursor detection region 210a illustrated in FIG. 8. The execution unit 45 sets the cursor detection region 210 of the grid point 147 in the grid point selected state when a grid point selection operation for the grid point 147 is received as the second cursor detection region 210b illustrated in FIG. 12. When receiving the first setting data, the execution unit 45 sets the cursor detection region 210 in the grid point unselected state to be wider than the cursor detection region 210 in the grid point selected state.

The second setting field 191b receives the input operation performed by the user. When the user performs the input operation on the second setting field 191b, the second setting field 191b performs display indicating that the second setting field 191b is selected by the user. FIG. 20 illustrates that the second setting field 191b is not selected. When the input operation is performed on the second setting field 191b, input data related to the setting mode is transmitted from the input device 90 to the input and output unit 49. The input data related to the setting mode is second setting data indicating that the second setting is selected. The second setting relates to the setting of the cursor detection region 210. The second setting is, for example, a setting in which the cursor detection region 210 in the grid point unselected state is narrower than the cursor detection region 210 in the grid point selected state.

The input and output unit 49 receives the second setting data. The input and output unit 49 transmits the received second setting data to the execution unit 45. The execution unit 45 receives the second setting data. The execution unit 45 sets the cursor detection region 210 based on the second setting data. For example, the execution unit 45 sets the cursor detection region 210 of the grid point 147 in the grid point unselected state as the first cursor detection region 210a illustrated in FIG. 8. The execution unit 45 sets the cursor detection region 210 of the grid point 147 in the grid point selected state when the grid point selection operation for the grid point 147 is received as the second cursor detection region 210b illustrated in FIG. 9. When receiving the second setting data, the execution unit 45 sets the cursor detection region 210 in the grid point unselected state to be narrower than the cursor detection region 210 in the grid point selected state.

The first setting and the second setting are not limited to the setting of the cursor detection region 210 of the grid point 147. The first setting and the second setting may be a setting of the cursor detection region 210 of the grid line 145. The first setting and the second setting may be a setting of the cursor detection region 210 in the grid point unselected state or a setting of the cursor detection region 210 in the grid point selected state. The first setting and the second setting are appropriately set.

Receiving the setting switching operation of switching between the first setting and the second setting is further provided. In the first setting, the first cursor detection region 210a is wider than the second cursor detection region 210b, and in the second setting, the first cursor detection region 210a is narrower than the second cursor detection region 210b.

By switching the setting of the cursor detection region 210 in the detection region setter 191, the user can set the cursor detection region 210 in an easy-operating-manner.

The user performs the input operation on the grid line 145 or the grid point 147 in the preview image 143, and is not limited thereto. The user may perform the input operation using an outer edge of the preview image 143 as an outer edge image. The preview image 143 may be implemented by a plurality of divided images. The user performs the input operation on the divided images. The preview image 143 may include a grid point image corresponding to the grid point 147. The user performs the input operation on the grid point image. The outer edge image, the divided image, and the grid point image correspond to examples of an image.

The present disclosure will be summarized as follows.

### Appendix 1

A control method according to the present disclosure includes: shifting, when a selection operation for an image displayed on a display screen is received in a first detection region including a display position of the image, the image from an unselected state to a selected state; and executing, when an image operation for the image in the selected state is received in a second detection region, processing corresponding to the image operation on the image in the selected state, the second detection region including the display position and being different from the first detection region.

Since the first detection region is different from the second detection region, operability of a user is improved. When the first detection region is wider than the second detection region, a possibility of occurrence of an erroneous operation on the image in the selected state is reduced. When the second detection region is wider than the first detection region, the user can easily operate the image in the selected state.

### Appendix 2

The control method according to the present disclosure is directed to the control method according to Appendix 1, in which when a display image adjacent to the image is displayed on the display screen, the first detection region and the second detection region are set based on a distance between the image and the display image.

By setting the first detection region and the second detection region based on the distance between the image and the adjacent display image, a distance between the second detection region of the image and the first detection region of the adjacent display image can be adjusted.

### Appendix 3

The control method according to the present disclosure is directed to the control method according to Appendix 1 or 2, further includes: receiving a switching operation of switching between a first mode and a second mode, in which in the first mode, the first detection region is wider than the second detection region, and in the second mode, the first detection region is narrower than the second detection region.

The user can set the first detection region and the second detection region in an easy-operating-manner by switching between the first mode and the second mode.

### Appendix 4

The control method according to the present disclosure is directed to the control method according to any one of Appendixes 1 to 3, in which the image operation is a movement operation, and the processing is movement processing of moving the image from the display position to a movement position designated based on the movement operation.

The user can move the image in the selected state.

### Appendix 5

The control method according to the present disclosure is directed to the control method according to Appendix 4, in which when the movement processing is executed on the image, correction data including position information related to the movement position is generated, and the correction data is output.

The correction data including the position information on the image moved to the movement position by the movement processing can be output to a projector. The projector can perform various types of processing by using the output position information.

### Appendix 6

A control device according to the present disclosure includes: one or more processors configured to shift, when a selection operation for an image displayed on a display screen is received in a first detection region including a display position of the image, the image from an unselected state to a selected state, and execute, when an image operation for the image in the selected state is received in a second detection region, processing corresponding to the image operation on the image in the selected state, the second detection region including the display position and being different from the first detection region; and an interface circuit configured to receive the selection operation and the image operation.

Since the first detection region is different from the second detection region, the control device can improve the operability of the user.

### Appendix 7

A non-transitory computer-readable storage medium stores a program according to the present disclosure, and the program causes a processor of a control device to execute operations including: shifting, when a selection operation for an image displayed on a display screen is received in a first detection region including a display position of the image, the image from an unselected state to a selected state; and executing, when an image operation for the image in the selected state is received in a second detection region, processing corresponding to the image operation on the image in the selected state, the second detection region including the display position and being different from the first detection region.

Since the first detection region is different from the second detection region, the program can provide the control device with high operability.

What is claimed is:

1. A control method comprising:
shifting, when a selection operation for an image displayed on a display screen is received in a first detection region including a display position of the image, the image from an unselected state to a selected state; and
executing, when an image operation for the image in the selected state is received in a second detection region, processing corresponding to the image operation on the image in the selected state, the second detection region including the display position and being different from the first detection region.

2. The control method according to claim 1, wherein
when a display image adjacent to the image is displayed on the display screen,
the first detection region and the second detection region are set based on a distance between the image and the display image.

3. The control method according to claim 1, further comprising:
receiving a switching operation of switching between a first mode and a second mode, wherein
in the first mode, the first detection region is wider than the second detection region, and
in the second mode, the first detection region is narrower than the second detection region.

4. The control method according to claim 1, wherein
the image operation is a movement operation, and
the processing is movement processing of moving the image from the display position to a movement position designated based on the movement operation.

5. The control method according to claim 4, wherein
when the movement processing is executed on the image,
generating correction data including position information related to the movement position, and
outputting the correction data.

6. A control device comprising:
one or more processors programmed to
shift, when a selection operation for an image displayed on a display screen is received in a first detection region including a display position of the image, the image from an unselected state to a selected state, and
execute, when an image operation for the image in the selected state is received in a second detection region, processing corresponding to the image operation on the image in the selected state, the second detection region including the display position and being different from the first detection region; and
an interface circuit configured to receive the selection operation and the image operation.

7. A non-transitory computer-readable storage medium storing a program, the program causing a processor of a control device to execute operations comprising:
shifting, when a selection operation for an image displayed on a display screen is received in a first detection region including a display position of the image, the image from an unselected state to a selected state; and
executing, when an image operation for the image in the selected state is received in a second detection region, processing corresponding to the image operation on the image in the selected state, the second detection region including the display position and being different from the first detection region.
